(19) United States
(12) Patent Application Publication
(10) Pub. No.: US 2016/0145393 A1
(43) Pub. Date: May 26, 2016

(54) PROCESS FOR PRODUCTION OF POLY(ARYLENE SULFIDE)

(71) Applicant: Chevron Phillips Chemical Company LP, The Woodlands, TX (US)

(72) Inventors: R. Shawn Childress, Bartlesville, OK (US); Jeffrey S. Fodor, Bartlesville, OK (US); David A. Soules, Bartlesville, OK (US); Jeffrey L. Swan, Pawhuska, OK (US); Thomas M. Clark, Bartlesville, OK (US)

(21) Appl. No.: 14/550,630

(22) Filed: Nov. 21, 2014

(51) Int. Cl. C08G 75/14

(52) U.S. Cl. CPC C08G 75/14

(57) ABSTRACT

A process for producing a poly(arylene sulfide) polymer comprising (a) polymerizing reactants in a reaction vessel to produce a poly(arylene sulfide) reaction mixture, (b) processing at least a portion of the poly(arylene sulfide) reaction mixture to obtain a poly(arylene sulfide) reaction mixture downstream product, and (c) contacting a by-product treatment additive with at least a portion of the poly(arylene sulfide) reaction mixture and/or downstream product thereof, and (d) processing at least a portion of the poly(arylene sulfide) reaction mixture downstream product to yield salt solids particulates, wherein the by-product treatment additive reduces agglomeration of the salt solids particulates.

### TECHNICAL FIELD

The present disclosure relates to a process of producing polymers, more specifically poly(arylene sulfide) polymers.

### BACKGROUND

Polymers, such as poly(arylene sulfide) polymers and their derivatives, are used for the production of a wide variety of articles. Generally, the process for producing a particular polymer and any steps thereof can drive the cost of such particular polymer, and consequently influences the economics of polymer articles. Thus, there is an ongoing need to develop and/or improve processes for producing these polymers.

### BRIEF SUMMARY

Disclosed herein is a process for producing a poly(arylene sulfide) polymer comprising (a) polymerizing reactants in a reaction vessel to produce a poly(arylene sulfide) reaction mixture, (b) processing at least a portion of the poly(arylene sulfide) reaction mixture to obtain a poly(arylene sulfide) reaction mixture downstream product, and (c) contacting a by-product treatment additive with at least a portion of the poly(arylene sulfide) reaction mixture and/or downstream product thereof, and (d) processing at least a portion of the poly(arylene sulfide) reaction mixture downstream product to yield salt solids particulates, wherein the by-product treatment additive reduces agglomeration of the salt solids particulates.

Further disclosed herein is a process for producing a poly(arylene sulfide) polymer comprising (a) polymerizing reactants in a reaction vessel to produce a poly(arylene sulfide) reaction mixture, (b) washing at least a portion of the poly(arylene sulfide) reaction mixture with a polar organic compound and/or water to obtain a poly(arylene sulfide) polymer and a first slurry, (c) contacting at least a portion of the first slurry with a by-product treatment additive to yield a treated first slurry having a pH of from about 4 to about 11, (d) evaporating at least portion of the treated first slurry to obtain a by-product slurry comprising poly(arylene sulfide) polymer impurities, wherein a weight average molecular weight of the poly(arylene sulfide) polymer impurities is by from about 1.01 times greater to about 40 times greater than a weight average molecular weight of poly(arylene sulfide) polymer impurities of an otherwise similar by-product slurry in the absence of treatment with the by-product treatment additive, and (e) evaporating at least portion of the by-product slurry to yield salt solids particulates, wherein the by-product treatment additive reduces agglomeration of the salt solids particulates.

Also disclosed herein is a process for producing a poly(arylene sulfide) polymer comprising (a) polymerizing reactants in a reaction vessel to produce a poly(arylene sulfide) reaction mixture, (b) contacting at least a portion of the poly(arylene sulfide) reaction mixture with a by-product treatment additive to yield a treated poly(arylene sulfide) reaction mixture, (c) washing at least a portion of the treated poly(arylene sulfide) reaction mixture with a polar organic compound and/or water to obtain a poly(arylene sulfide) polymer and a first slurry having a pH of from about 4 to about 11, (d) evaporating at least portion of the first slurry to obtain a by-product slurry comprising poly(arylene sulfide) polymer impurities, wherein a weight average molecular weight of the poly(arylene sulfide) polymer impurities is by from about 1.01 times greater to about 40 times greater than a weight average molecular weight of poly(arylene sulfide) polymer impurities of an otherwise similar by-product slurry in the absence of treatment with the by-product treatment additive, and (e) evaporating at least portion of the by-product slurry to yield salt solids particulates, wherein the by-product treatment additive reduces agglomeration of the salt solids particulates.

### BRIEF DESCRIPTION OF THE DRAWINGS

For a detailed description of the preferred embodiments of the disclosed processes, reference will now be made to the accompanying drawings in which:

FIG. 1 displays a process flow diagram of an embodiment of a process for production of poly(phenylene sulfide) (PPS), wherein a first slurry can be contacted with a by-product treatment additive;

FIG. 2 displays a process flow diagram of an embodiment of a process for production of PPS, wherein a poly(phenylene sulfide) reaction mixture can be contacted with a by-product treatment additive;

FIG. 3 displays a graph of a torque of a dryer motor over time for drying samples with various pH values, with and without a by-product treatment additive;

FIG. 4A displays a graph of a torque of a dryer motor over time for samples with and without various by-product treatment additives;

FIG. 4B displays a graph of a torque of a dryer motor over time for samples with and without sodium bicarbonate;

FIG. 4C displays a graph of a torque of a dryer motor over time for samples with and without sodium carbonate;

FIG. 4D displays a graph of a torque of a dryer motor over time for samples with and without acetic acid;

FIG. 4E displays a graph of a torque of a dryer motor over time for samples with and without dry ice;

FIG. 5A displays molecular weight profiles of oligomers recovered from a step of evaporating a first slurry in a first stage concentrator after various time frames of using a by-product treatment additive in a PPS production process; and

FIG. 5B displays a molecular weight profile of oligomers recovered from a step of evaporating a first slurry in a second stage concentrator after various time frames of using a by-product treatment additive in a PPS production process.

### DETAILED DESCRIPTION

Disclosed herein are processes for producing poly(arylene sulfide) polymers. The present application relates to poly(arylene sulfide) polymers, also referred to herein simply as “poly(arylene sulfide).” In the various embodiments disclosed herein, it is to be expressly understood that reference to poly(arylene sulfide) polymer specifically includes, without limitation, poly(phenylene sulfide) polymer (or simply, poly(phenylene sulfide)), also referred to as PPS polymer (or simply, PPS).

In an embodiment, a process for producing a poly(arylene sulfide) polymer can comprise the steps of (a) polymerizing reactants in a reaction vessel to produce a poly(arylene sulfide) reaction mixture; (b) processing at least a portion of the poly(arylene sulfide) reaction mixture to obtain a poly(arylene sulfide) reaction mixture downstream product; (c) contacting a by-product treatment additive with at least a portion of the poly(arylene sulfide) reaction mixture and/or downstream product thereof; and (d) processing at least a portion of the poly(arylene sulfide) reaction mixture downstream product to yield salt solids particulates, wherein the by-product treatment additive can reduce agglomeration of the salt solids particulates. In an embodiment, step (b) processing at least a portion of the poly(arylene sulfide) reaction mixture can comprise washing the at least a portion of the poly(arylene sulfide) reaction mixture with a polar organic compound and/or water to obtain a washed poly(arylene sulfide) polymer and a first slurry, wherein the by-product treatment additive can be contacted with at least a portion of the first slurry, and wherein the first slurry can have a pH of from about 4 to about 11 after contacting with the by-product treatment additive.

In an embodiment, a process for producing a poly(arylene sulfide) polymer can comprise the steps of (a) polymerizing reactants in a reaction vessel to produce a poly(arylene sulfide) reaction mixture; (b) washing at least portion of the poly(arylene sulfide) reaction mixture with a polar organic compound and/or water to obtain a poly(arylene sulfide) polymer and a first slurry; (c) contacting at least a portion of the first slurry with a by-product treatment additive to yield a treated first slurry having a pH of from about 4 to about 11; (d) evaporating at least portion of the treated first slurry to obtain a by-product slurry comprising poly(arylene sulfide) polymer impurities, wherein a weight average molecular weight of the poly(arylene sulfide) polymer impurities can be by from about 1.01 times greater to about 40 times greater than a weight average molecular weight of poly(arylene sulfide) polymer impurities of an otherwise similar by-product slurry in the absence of treatment with the by-product treatment additive; and (e) evaporating at least portion of the by-product slurry to yield salt solids particulates, wherein the by-product treatment additive can reduce agglomeration of the salt solids particulates.

In an embodiment, a process for producing a poly(arylene sulfide) polymer can comprise the steps of (a) polymerizing reactants in a reaction vessel to produce a poly(arylene sulfide) reaction mixture; (b) contacting at least a portion of the poly(arylene sulfide) reaction mixture with a by-product treatment additive to yield a treated poly(arylene sulfide) reaction mixture; (c) washing at least a portion of the treated poly(arylene sulfide) reaction mixture with a polar organic compound and/or water to obtain a poly(arylene sulfide) polymer and a first slurry having a pH of from about 4 to about 11; (d) evaporating at least portion of the first slurry to obtain a by-product slurry comprising poly(arylene sulfide) polymer impurities, wherein a weight average molecular weight of the poly(arylene sulfide) polymer impurities can be by from about 1.01 times greater to about 40 times greater than a weight average molecular weight of poly(arylene sulfide) polymer impurities of an otherwise similar by-product slurry in the absence of treatment with the by-product treatment additive; and (e) evaporating at least portion of the by-product slurry to yield salt solids particulates, wherein the by-product treatment additive can reduce agglomeration of the salt solids particulates.

In an embodiment, a process of the present disclosure can comprise contacting a by-product treatment additive with a poly(arylene sulfide) reaction mixture and/or downstream product thereof to reduce agglomeration of salt solids particulates. While the present disclosure will be discussed in detail in the context of a process for producing a poly(arylene sulfide) polymer, it should be understood that such process or any steps thereof can be applied in a process for producing any other suitable polymer. The polymer can comprise any polymer compatible with the disclosed methods and materials.

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed. (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Groups of elements of the table are indicated using the numbering scheme indicated in the version of the periodic table of elements published in Chemical and Engineering News, 63(5), 27, 1985. In some instances a group of elements can be indicated using a common name assigned to the group; for example alkali earth metals (or alkali metals) for Group 1 elements, alkaline earth metals (or alkaline metals) for Group 2 elements, transition metals for Group 3-12 elements, and halogens for Group 17 elements.

A chemical “group” is described according to how that group is formally derived from a reference or “parent” compound, for example, by the number of hydrogen atoms formally removed from the parent compound to generate the group, even if that group is not literally synthesized in this manner. These groups can be utilized as substituents or coordinated or bonded to metal atoms. By way of example, an “alkyl group” formally can be derived by removing one hydrogen atom from an alkane, while an “alkylene group” formally can be derived by removing two hydrogen atoms from an alkane. Moreover, a more general term can be used to encompass a variety of groups that formally are derived by removing any number (“one or more”) hydrogen atoms from a parent compound, which in this example can be described as an “alkane group,” and which encompasses an “alkyl group,” an “alkylene group,” and materials have three or more hydrogen atoms, as necessary for the situation, removed from the alkane. Throughout, the disclosure that a substituent, ligand, or other chemical moiety can constitute a particular “group” implies that the well-known rules of chemical structure and bonding are followed when that group is employed as described. When describing a group as being “derived by,” “derived from,” “formed by,” or “formed from,” such terms are used in a formal sense and are not intended to reflect any specific synthetic methods or procedure, unless specified otherwise or the context requires otherwise.

The term “substituted” when used to describe a group, for example, when referring to a substituted analog of a particular group, is intended to describe any non-hydrogen moiety that formally replaces a hydrogen in that group, and is intended to be non-limiting. A group or groups can also be referred to herein as “unsubstituted” or by equivalent terms such as “non-substituted,” which refers to the original group in which a non-hydrogen moiety does not replace a hydrogen within that group. “Substituted” is intended to be non-limiting and include inorganic substituents or organic substituents.

Unless otherwise specified, any carbon-containing group for which the number of carbon atoms is not specified can have, according to proper chemical practice, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, or any range or combination of ranges between these values. For example, unless otherwise specified, any carbon-containing group can have from 1 to 30 carbon atoms, from 1 to 25 carbon atoms, from 1 to 20 carbon atoms, from 1 to 15 carbon atoms, from 1 to 10 carbon atoms, or from 1 to 5 carbon atoms, and the like. Moreover, other identifiers or qualifying terms can be utilized to indicate the presence or absence of a particular substituent, a particular regiochemistry and/or stereochemistry, or the presence or absence of a branched underlying structure or backbone.

Within this disclosure the normal rules of organic nomenclature will prevail. For instance, when referencing substituted compounds or groups, references to substitution patterns are taken to indicate that the indicated group(s) is (are) located at the indicated position and that all other non-indicated positions are hydrogen. For example, reference to a 4-substituted phenyl group indicates that there is a non-hydrogen substituent located at the 4 position and hydrogens located at the 2, 3, 5, and 6 positions. By way of another example, reference to a 3-substituted naphth-2-yl indicates that there is a non-hydrogen substituent located at the 3 position and hydrogens located at the 1, 4, 5, 6, 7, and 8 positions. References to compounds or groups having substitutions at positions in addition to the indicated position will be referenced using comprising or some other alternative language. For example, a reference to a phenyl group comprising a substituent at the 4 position refers to a group having a non-hydrogen atom at the 4 position and hydrogen or any non-hydrogen group at the 2, 3, 5, and 6 positions.

The term “organyl group” is used herein in accordance with the definition specified by IUPAC: an organic substituent group, regardless of functional type, having one free valence at a carbon atom. Similarly, an “organylene group” refers to an organic group, regardless of functional type, derived by removing two hydrogen atoms from an organic compound, either two hydrogen atoms from one carbon atom or one hydrogen atom from each of two different carbon atoms. An “organic group” refers to a generalized group formed by removing one or more hydrogen atoms from carbon atoms of an organic compound. Thus, an “organyl group,” an “organylene group,” and an “organic group” can contain organic functional group(s) and/or atom(s) other than carbon and hydrogen, that is, an organic group that can comprise functional groups and/or atoms in addition to carbon and hydrogen. For instance, non-limiting examples of atoms other than carbon and hydrogen include halogens, oxygen, nitrogen, phosphorus, and the like. Non-limiting examples of functional groups include ethers, aldehydes, ketones, esters, sulfides, amines, and phosphines, and so forth. In one aspect, the hydrogen atom(s) removed to form the “organyl group,” “organylene group,” or “organic group” can be attached to a carbon atom belonging to a functional group, for example, an acyl group (—C(O)R), a formyl group (—C(O)H), a carboxy group (—C(O)OH), a hydrocarboxycarbonyl group (—C(O)OR), a cyano group (—C≡N), a carbamoyl group (—C(O)NH₂), a N-hydrocarbylcarbamoyl group (—C(O)NHR), or N,N′-dihydrocarbylcarbamoyl group (—C(O)NR₂), among other possibilities. In another aspect, the hydrogen atom(s) removed to form the “organyl group,” “organylene group,” or “organic group” can be attached to a carbon atom not belonging to, and remote from, a functional group, for example, —CH₂C(O)CH₃, —CH₂NR₂. An “organyl group,” “organylene group,” or “organic group” can be aliphatic, inclusive of being cyclic or acyclic, or can be aromatic. “Organyl groups,” “organylene groups,” and “organic groups” also encompass heteroatom-containing rings, heteroatom-containing ring systems, heteroaromatic rings, and heteroaromatic ring systems. “Organyl groups,” “organylene groups,” and “organic groups” can be linear or branched unless otherwise specified. Finally, it is noted that the “organyl group,” “organylene group,” or “organic group” definitions include “hydrocarbyl group,” “hydrocarbylene group,” “hydrocarbon group,” respectively, and “alkyl group,” “alkylene group,” and “alkane group,” respectively, as members.

The term “hydrocarbon” whenever used in this specification and claims refers to a compound containing only carbon and hydrogen. Other identifiers can be utilized to indicate the presence of particular groups in the hydrocarbon (e.g. halogenated hydrocarbon indicates the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Similarly, a “hydrocarbylene group” refers to a group formed by removing two hydrogen atoms from a hydrocarbon, either two hydrogen atoms from one carbon atom or one hydrogen atom from each of two different carbon atoms. Therefore, in accordance with the terminology used herein, a “hydrocarbon group” refers to a generalized group formed by removing one or more hydrogen atoms (as necessary for the particular group) from a hydrocarbon. A “hydrocarbyl group,” “hydrocarbylene group,” and “hydrocarbon group” can be acyclic or cyclic groups, and/or can be linear or branched. A “hydrocarbyl group,” “hydrocarbylene group,” and “hydrocarbon group” can include rings, ring systems, aromatic rings, and aromatic ring systems, which contain only carbon and hydrogen. “Hydrocarbyl groups,” “hydrocarbylene groups,” and “hydrocarbon groups” include, by way of example, aryl, arylene, arene groups, alkyl, alkylene, alkane group, cycloalkyl, cycloalkylene, cycloalkane groups, aralkyl, aralkylene, and aralkane groups, respectively, among other groups as members.

The term “alkane” whenever used in this specification and claims refers to a saturated hydrocarbon compound. Other identifiers can be utilized to indicate the presence of particular groups in the alkane (e.g. halogenated alkane indicates the presence of one or more halogen atoms replacing an equivalent number of hydrogen atoms in the alkane). The term “alkyl group” is used herein in accordance with the definition specified by IUPAC: a univalent group formed by removing a hydrogen atom from an alkane. Similarly, an “alkylene group” refers to a group formed by removing two hydrogen atoms from an alkane (either two hydrogen atoms from one carbon atom or one hydrogen atom from two different carbon atoms). An “alkane group” is a general term that refers to a group formed by removing one or more hydrogen atoms (as necessary for the particular group) from an alkane. An “alkyl group,” “alkylene group,” and “alkane group” can be acyclic or cyclic groups, and/or can be linear or branched unless otherwise specified.

A “cycloalkane” is a saturated cyclic hydrocarbon, with or without side chains, for example, cyclobutane. Other identifiers can be utilized to indicate the presence of particular groups in the cycloalkane (e.g. halogenated cycloalkane indicates the presence of one or more halogen atoms replacing an equivalent number of hydrogen atoms in the cycloalkane).

Unsaturated cyclic hydrocarbons having one or more endocyclic double or triple bonds are called cycloalkenes and cycloalkynes, respectively. Cycloalkenes and cycloalkynes having only one, only two, and only three endocyclic double or triple bonds, respectively, can be identified by use of the term “mono,” “di,” and “tri within the name of the cycloalkene or cycloalkyne. Cycloalkenes and cycloalkynes can further identify the position of the endocyclic double or triple bonds. Other identifiers can be utilized to indicate the presence of particular groups in the cycloalkane (e.g. halogenated cycloalkane indicates that the presence of one or more halogen atoms replacing an equivalent number of hydrogen atoms in the cycloalkane).

A “cycloalkyl group” is a univalent group derived by removing a hydrogen atom from a ring carbon atom from a cycloalkane. For example, a 1-methylcyclopropyl group and a 2-methylcyclopropyl group are illustrated as follows.

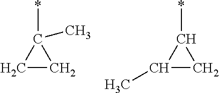

Similarly, a “cycloalkylene group” refers to a group derived by removing two hydrogen atoms from a cycloalkane, at least one of which is a ring carbon. Thus, a “cycloalkylene group” includes both a group derived from a cycloalkane in which two hydrogen atoms are formally removed from the same ring carbon, a group derived from a cycloalkane in which two hydrogen atoms are formally removed from two different ring carbons, and a group derived from a cycloalkane in which a first hydrogen atom is formally removed from a ring carbon and a second hydrogen atom is formally removed from a carbon atom that is not a ring carbon. A “cycloalkane group” refers to a generalized group formed by removing one or more hydrogen atoms (as necessary for the particular group and at least one of which is a ring carbon) from a cycloalkane. It should be noted that according to the definitions provided herein, general cycloalkane groups (including cycloalkyl groups and cycloalkylene groups) include those having zero, one, or more than one hydrocarbyl substituent groups attached to a cycloalkane ring carbon atom (e.g. a methylcyclopropyl group) and is member of the group of hydrocarbon groups. However, when referring to a cycloalkane group having a specified number of cycloalkane ring carbon atoms (e.g. cyclopentane group or cyclohexane group, among others), the base name of the cycloalkane group having a defined number of cycloalkane ring carbon atoms refers to the unsubstituted cycloalkane group. Consequently, a substituted cycloalkane group having a specified number of ring carbon atoms (e.g. substituted cyclopentane or substituted cyclohexane, among others) refers to the respective group having one or more substituent groups (including halogens, hydrocarbyl groups, or hydrocarboxy groups, among other substituent groups) attached to a cycloalkane group ring carbon atom. When the substituted cycloalkane group having a defined number of cycloalkane ring carbon atoms is a member of the group of hydrocarbon groups (or a member of the general group of cycloalkane groups), each substituent of the substituted cycloalkane group having a defined number of cycloalkane ring carbon atoms is limited to hydrocarbyl substituent group. One can readily discern and select general groups, specific groups, and/or individual substituted cycloalkane group(s) having a specific number of ring carbons atoms which can be utilized as member of the hydrocarbon group (or a member of the general group of cycloalkane groups).

An aromatic compound is a compound containing a cyclically conjugated double bond system that follows the Hückel (4n+2) rule and contains (4n+2) pi-electrons, where n is an integer from 1 to 5. Aromatic compounds include “arenes” (hydrocarbon aromatic compounds) and “heteroarenes,” also termed “hetarenes” (heteroaromatic compounds formally derived from arenes by replacement of one or more methine (—C═) carbon atoms of the cyclically conjugated double bond system with a trivalent or divalent heteroatoms, in such a way as to maintain the continuous pi-electron system characteristic of an aromatic system and a number of out-of-plane pi-electrons corresponding to the Hückel rule (4n+2). While arene compounds and heteroarene compounds are mutually exclusive members of the group of aromatic compounds, a compound that has both an arene group and a heteroarene group are generally considered a heteroarene compound. Aromatic compounds, arenes, and heteroarenes can be monocyclic (e.g., benzene, toluene, furan, pyridine, methylpyridine) or polycyclic unless otherwise specified. Polycyclic aromatic compounds, arenes, and heteroarenes, include, unless otherwise specified, compounds wherein the aromatic rings can be fused (e.g., naphthalene, benzofuran, and indole), compounds where the aromatic groups can be separate and joined by a bond (e.g., biphenyl or 4-phenylpyridine), or compounds where the aromatic groups are joined by a group containing linking atoms (e.g., carbon—the methylene group in diphenylmethane; oxygen—diphenyl ether; nitrogen—triphenyl amine; among others linking groups). As disclosed herein, the term “substituted” can be used to describe an aromatic group, arene, or heteroarene wherein a non-hydrogen moiety formally replaces a hydrogen in the compound, and is intended to be non-limiting.

An “aromatic group” refers to a generalized group formed by removing one or more hydrogen atoms (as necessary for the particular group and at least one of which is an aromatic ring carbon atom) from an aromatic compound. For a univalent “aromatic group,” the removed hydrogen atom must be from an aromatic ring carbon. For an “aromatic group” formed by removing more than one hydrogen atom from an aromatic compound, at least one hydrogen atom must be from an aromatic hydrocarbon ring carbon. Additionally, an “aromatic group” can have hydrogen atoms removed from the same ring of an aromatic ring or ring system (e.g., phen-1,4-ylene, pyridin-2,3-ylene, naphth-1,2-ylene, and benzofuran-2,3-ylene), hydrogen atoms removed from two different rings of a ring system (e.g., naphth-1,8-ylene and benzofuran-2,7-ylene), or hydrogen atoms removed from two isolated aromatic rings or ring systems (e.g., bis(phen-4-ylene)methane).

An arene is aromatic hydrocarbon, with or without side chains (e.g. benzene, toluene, or xylene, among others). An “aryl group” is a group derived by the formal removal of a hydrogen atom from an aromatic ring carbon of an arene. It should be noted that the arene can contain a single aromatic hydrocarbon ring (e.g., benzene, or toluene), contain fused aromatic rings (e.g., naphthalene or anthracene), and/or contain one or more isolated aromatic rings covalently linked via a bond (e.g., biphenyl) or non-aromatic hydrocarbon group(s) (e.g., diphenylmethane). One example of an “aryl group” is ortho-tolyl (o-tolyl), the structure of which is shown here.

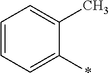 [SMILES: *c1ccccc1C]

Similarly, an “arylene group” refers to a group formed by removing two hydrogen atoms (at least one of which is from an aromatic ring carbon) from an arene. An “arene group” refers to a generalized group formed by removing one or more hydrogen atoms (as necessary for the particular group and at least one of which is an aromatic ring carbon) from an arene. However, if a group contains separate and distinct arene and heteroarene rings or ring systems (e.g., the phenyl and benzofuran moieties in 7-phenylbenzofuran) its classification depends upon the particular ring or ring system from which the hydrogen atom was removed, that is, a substituted arene group if the removed hydrogen came from the aromatic hydrocarbon ring or ring system carbon atom (e.g., the 2 carbon atom in the phenyl group of 6-phenylbenzofuran) and a heteroarene group if the removed hydrogen carbon came from a heteroaromatic ring or ring system carbon atom (e.g., the 2 or 7 carbon atom of the benzofuran group of 6-phenylbenzofuran). It should be noted that according the definitions provided herein, general arene groups (including an aryl group and an arylene group) include those having zero, one, or more than one hydrocarbyl substituent groups located on an aromatic hydrocarbon ring or ring system carbon atom (e.g., a toluene group or a xylene group, among others) and is a member of the group of hydrocarbon groups. However, a phenyl group (or phenylene group) and/or a naphthyl group (or naphthylene group) refer to the specific unsubstituted arene groups. Consequently, a substituted phenyl group or substituted naphthyl group refers to the respective arene group having one or more substituent groups (including halogens, hydrocarbyl groups, or hydrocarboxy groups, among others) located on an aromatic hydrocarbon ring or ring system carbon atom. When the substituted phenyl group and/or substituted naphthyl group is a member of the group of hydrocarbon groups (or a member of the general group of arene groups), each substituent is limited to a hydrocarbyl substituent group. One having ordinary skill in the art can readily discern and select general phenyl and/or naphthyl groups, specific phenyl and/or naphthyl groups, and/or individual substituted phenyl or substituted naphthyl groups which can be utilized as a member of the group of hydrocarbon groups (or a member of the general group of arene groups).

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of excludes any element, step, or ingredient not specified in the claim. The transitional phrase “consisting essentially of limits the scope of a claim to the specified materials or steps and those that do not materially affect the basic and novel characteristic(s) of the claimed invention. The term “consisting essentially of occupies a middle ground between closed terms like “consisting of” and fully open terms like “comprising.” Absent an indication to the contrary, when describing a compound or composition “consisting essentially of is not to be construed as “comprising,” but is intended to describe the recited component that includes materials which do not significantly alter composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of apply only to feature class to which is utilized and it is possible to have different transitional terms or phrases utilized with different features within a claim. For example a method can comprise several recited steps (and other non-recited steps) but utilize a catalyst system preparation consisting of specific or alternatively consisting essentially of specific steps but utilize a catalyst system comprising recited components and other non-recited components.

While compositions and methods are described in terms of “comprising” (or other broad term) various components and/or steps, the compositions and methods can also be described using narrower terms such as “consist essentially of or “consist of the various components and/or steps.

Use of the term “optionally” with respect to any element of a claim is intended to mean that the subject element is required, or alternatively, is not required. Both alternatives are intended to be within the scope of the claim.

The terms “a,” “an,” and “the” are intended, unless specifically indicated otherwise, to include plural alternatives, e.g., at least one. For any particular compound or group disclosed herein, any name or structure presented is intended to encompass all conformational isomers, regioisomers, and stereoisomers that can arise from a particular set of substituents, unless otherwise specified. For example, a general reference to pentane includes n-pentane, 2-methyl-butane, and 2,2-dimethylpropane and a general reference to a butyl group includes an n-butyl group, a sec-butyl group, an iso-butyl group, and t-butyl group. The name or structure also encompasses all enantiomers, diastereomers, and other optical isomers whether in enantiomeric or racemic forms, as well as mixtures of stereoisomers, as would be recognized by a skilled artisan, unless otherwise specified.

The terms “room temperature” or “ambient temperature” are used herein to describe any temperature from 15° C. to 35° C. wherein no external heat or cooling source is directly applied to the reaction vessel. Accordingly, the terms “room temperature” and “ambient temperature” encompass the individual temperatures and any and all ranges, subranges, and combinations of subranges of temperatures from 15° C. to 35° C. wherein no external heating or cooling source is directly applied to the reaction vessel. The term “atmospheric pressure” is used herein to describe an earth air pressure wherein no external pressure modifying means is utilized. Generally, unless practiced at extreme earth altitudes, “atmospheric pressure” is about 1 atmosphere (alternatively, about 14.7 psi or about 101 kPa).

Features within this disclosure that are provided as a minimum values can be alternatively stated as “at least” or “greater than or equal to” any recited minimum value for the feature disclosed herein. Features within this disclosure that are provided as a maximum values can be alternatively stated as “less than or equal to” any recited maximum value for the feature disclosed herein.

Embodiments disclosed herein can provide the materials listed as suitable for satisfying a particular feature of the embodiment delimited by the term “or.” For example, a particular feature of the disclosed subject matter can be disclosed as follows: Feature X can be A, B, or C. It is also contemplated that for each feature the statement can also be phrased as a listing of alternatives such that the statement “Feature X is A, alternatively B, or alternatively C” is also an embodiment of the present disclosure whether or not the statement is explicitly recited.

In an embodiment, the polymers disclosed herein are poly(arylene sulfide) polymers. In an embodiment, the polymer can comprise a poly(arylene sulfide). In other embodiments, the polymer can comprise a poly(phenylene sulfide). Herein, the polymer refers both to a material collected as the product of a polymerization reaction (e.g., a reactor or virgin resin) and a polymeric composition comprising a polymer and one or more additives. In an embodiment, a monomer (e.g., p-dichlorobenzene) can be polymerized using the methodologies disclosed herein to produce a polymer of the type disclosed herein. In an embodiment, the polymer can comprise a homopolymer or a copolymer. It is to be understood that an inconsequential amount of comonomer can be present in the polymers disclosed herein and the polymer still be considered a homopolymer. Herein an inconsequential amount of a comonomer refers to an amount that does not substantively affect the properties of the polymer disclosed herein. For example a comonomer can be present in an amount of less than about 1.0 wt. %, 0.5 wt. %, 0.1 wt. %, or 0.01 wt. %, based on the total weight of polymer.

Generally, poly(arylene sulfide) is a polymer comprising a —(Ar—S)— repeating unit, wherein Ar is an arylene group. Unless otherwise specified the arylene groups of the poly(arylene sulfide) can be substituted or unsubstituted; alternatively, substituted; or alternatively, unsubstituted. Additionally, unless otherwise specified, the poly(arylene sulfide) can include any isomeric relationship of the sulfide linkages in polymer; e.g., when the arylene group is a phenylene group the sulfide linkages can be ortho, meta, para, or combinations thereof.

In an aspect, poly(arylene sulfide) can contain at least 5, 10, 20, 30, 40, 50, 60, 70 mole percent of the —(Ar—S)— unit. In an embodiment, the poly(arylene sulfide) can contain up to 50, 70, 80, 90, 95, 99, or 100 mole percent of the —(Ar—S)— unit. In some embodiments, poly(arylene sulfide) can contain from any minimum mole percent of the —(Ar—S)— unit disclosed herein to any maximum mole percent of the —(Ar—S)— unit disclosed herein; for example, from 5 to 99 mole percent, 30 to 70 mole percent, or 70 to 95 mole percent of the —(Ar—S)— unit. Other ranges for the poly(arylene sulfide) units are readily apparent from the present disclosure. Poly(arylene sulfide) containing less than 100 percent —(Ar—S)— can further comprise units having one or more of the following structures, wherein (*) as used throughout the disclosure represents a continuing portion of a polymer chain or terminal group:

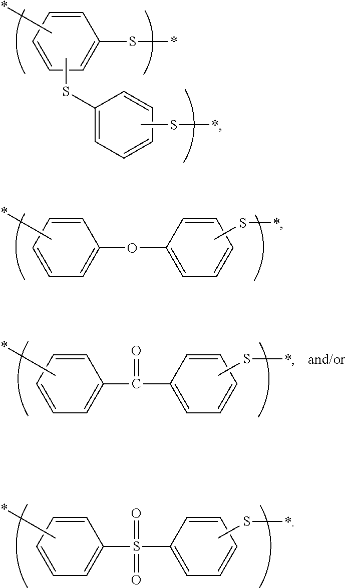

In an embodiment, the arylene sulfide unit can be represented by Formula I.

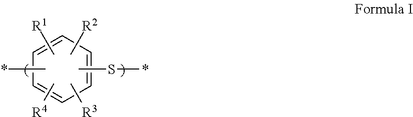

It should be understood, that within the arylene sulfide unit having Formula I, the relationship between the position of the sulfur atom of the arylene sulfide unit and the position where the next arylene sulfide unit can be ortho, meta, para, or any combination thereof. Generally, the identity of R¹, R², R³, and R⁴ are independent of each other and can be any group described herein.

In an embodiment, R¹, R², R³, and R⁴ independently can be hydrogen or a substituent. In some embodiments, each substituent independently can be an organyl group, an organocarboxy group, or an organothio group; alternatively, an organyl group or an organocarboxy group; alternatively, an organyl group or an organothio group; alternatively, an organyl group; alternatively, an organocarboxy group; or alternatively, or an organothio group. In other embodiments, each substituent independently can be a hydrocarbyl group, a hydrocarboxy group, or a hydrocarbylthio group; alternatively, a hydrocarbyl group or a hydrocarboxy group; alternatively, a hydrocarbyl group or a hydrocarbylthio group; alternatively, a hydrocarbyl group; alternatively, a hydrocarboxy group; or alternatively, or a hydrocarbylthio group. In yet other embodiments, each substituent independently can be an alkyl group, an alkoxy group, or an alkylthio group; alternatively, an alkyl group or an alkoxy group; alternatively, an alkyl group or an alkylthio group; alternatively, an alkyl group; alternatively, an alkoxy group; or alternatively, or an alkylthio group.

In an embodiment, each organyl group which can be utilized as R¹, R², R³, and/or R⁴ independently can be a C₁ to C₂₀ organyl group; alternatively, a C₁ to C₁₀ organyl group; or alternatively, a C₁ to C₅ organyl group. In an embodiment, each organocarboxy group which can be utilized as R¹, R², R³, and/or R⁴ independently can be a C₁ to C₂₀ organocarboxy group; alternatively, a C₁ to C₁₀ organocarboxy group; or alternatively, a C₁ to C₅ organocarboxy group. In an embodiment, each organothio group which can be utilized as R¹, R², R³, and/or R⁴ independently can be a C₁ to C₂₀ organothio group; alternatively, a C₁ to C₁₀ organothio group; or alternatively, a C₁ to C₅ organothio group. In an embodiment, each hydrocarbyl group which can be utilized as R¹, R², R³, and/or R⁴ independently can be a C₁ to C₂₀ hydrocarbyl group;

alternatively, a C₁ to C₁₀ hydrocarbyl group; or alternatively, a C₁ to C₅ hydrocarbyl group. In an embodiment, each hydrocarboxy group which can be utilized as R¹, R², R³, and/or R⁴ independently can be a C₁ to C₂₀ hydrocarboxy group; alternatively, a C₁ to C₁₀ hydrocarboxy group; or alternatively, a C₁ to C₅ hydrocarboxy group. In an embodiment, each hydrocarbyl group which can be utilized as R¹, R², R³, and/or R⁴ independently can be a C₁ to C₂₀ hydrocarbylthio group; alternatively, a C₁ to C₁₀ hydrocarbylthio group; or alternatively, a C₁ to C₅ hydrocarbylthio group. In an embodiment, each alkyl group which can be utilized as R¹, R², R³, and/or R⁴ independently can be a C₁ to C₂₀ alkyl group; alternatively, a C₁ to C₁₀ alkyl group; or alternatively, a C₁ to C₅ alkyl group. In an embodiment, each alkoxy group which can be utilized as R¹, R², R³, and/or R⁴ independently can be a C₁ to C₂₀ alkoxy group; alternatively, a C₁ to C₁₀ alkoxy group; or alternatively, a C₁ to C₅ alkoxy group. In an embodiment, each alkoxy group which can be utilized as R¹, R², R³, and/or R⁴ independently can be a C₁ to C₂₀ alkylthio group; alternatively, a C₁ to C₁₀ alkylthio group; or alternatively, a C₁ to C₅ alkylthio group.

In some embodiments, each non-hydrogen R¹, R², R³, and/or R⁴ independently can be an alkyl group, a substituted alkyl group, a cycloalkyl group, a substituted cycloalkyl group, an aryl group, a substituted aryl group, an aralkyl group, or a substituted aralkyl group. In other embodiments, each non-hydrogen R¹, R², R³, and/or R⁴ independently can be an alkyl group or a substituted alkyl group; alternatively, a cycloalkyl group or a substituted cycloalkyl group; alternatively, an aryl group or a substituted aryl group; or alternatively, a aralkyl group or a substitute aralkyl group. In yet other embodiments, each non-hydrogen R¹, R², R³, and/or R⁴ independently can be an alkyl group; alternatively, a substituted alkyl group; alternatively, a cycloalkyl group; alternatively, a substituted cycloalkyl group; alternatively, an aryl group; alternatively, a substituted aryl group; alternatively, an aralkyl group; or alternatively, a substituted aralkyl group. Generally, the alkyl group, substituted alkyl group, cycloalkyl group, substituted cycloalkyl group, aryl group, substituted aryl group, aralkyl group, and substituted aralkyl group which can be utilized as R can have the same number of carbon atoms as any organyl group or hydrocarbyl group of which it is a member.

In an embodiment, each non-hydrogen R¹, R², R³, and/or R⁴ independently a methyl group, an ethyl group, a propyl group, a butyl group, a pentyl group, a hexyl group, a heptyl group, an octyl group, a nonyl group, or a decyl group. In some embodiments, each non-hydrogen R¹, R², R³, and/or R⁴ independently can be a methyl group, an ethyl group, a n-propyl group, an iso-propyl group, a n-butyl group, an iso-butyl group, a sec-butyl group, a tert-butyl group, an n-pentyl group, an iso-pentyl group, a sec-pentyl group, or a neopentyl group; alternatively, a methyl group, an ethyl group, an iso-propyl group, a tert-butyl group, or a neopentyl group; alternatively, a methyl group; alternatively, an ethyl group; alternatively, a n-propyl group; alternatively, an iso-propyl group; alternatively, a tert-butyl group; or alternatively, a neopentyl group. In some embodiments, any of the disclosed alkyl groups can be substituted. Substituents for the substituted alkyl group are independently disclosed herein and can be utilized without limitation to further describe the substituted alkyl group which can be utilized as a non-hydrogen R¹, R², R³, and/or R⁴.

In an aspect, each cycloalkyl group (substituted or unsubstituted) which can be utilized as a non-hydrogen R¹, R², R³, and/or R⁴ independently can be a C₄ to C₂₀ cycloalkyl group (substituted or unsubstituted); alternatively, a C₅ to C₁₅ cycloalkyl group (substituted or unsubstituted); or alternatively, a C₅ to C₁₀ cycloalkyl group (substituted or unsubstituted). In an embodiment, each non-hydrogen R¹, R², R³, and/or R⁴ independently can be a cyclobutyl group, a substituted cyclobutyl group, a cyclopentyl group, a substituted cyclopentyl group, a cyclohexyl group, a substituted cyclohexyl group, a cycloheptyl group, a substituted cycloheptyl group, a cyclooctyl group, or a substituted cyclooctyl group. In other embodiments, each non-hydrogen R¹, R², R³, and/or R⁴ independently can be a cyclopentyl group, a substituted cyclopentyl group, a cyclohexyl group, or a substituted cyclohexyl group; alternatively, a cyclopentyl group or a substituted cyclopentyl group; or alternatively, a cyclohexyl group or a substituted cyclohexyl group. In further embodiments, each non-hydrogen R¹, R², R³, and/or R⁴ independently can be a cyclopentyl group; alternatively, a substituted cyclopentyl group; a cyclohexyl group; or alternatively, a substituted cyclohexyl group. Substituents for the substituted cycloalkyl group are independently disclosed herein and can be utilized without limitation to further describe the substituted cycloalkyl group which can be utilized as a non-hydrogen R group. Substituents for the substituted cycloalkyl groups (general or specific) are independently disclosed herein and can be utilized without limitation to further describe the substituted cycloalkyl groups which can be utilized as a non-hydrogen R¹, R², R³, and/or R⁴.

In an aspect, the aryl group (substituted or unsubstituted) which can be utilized as a non-hydrogen R¹, R², R³, and/or R⁴ independently can be a C₆-C₂₀ aryl group (substituted or unsubstituted); alternatively, a C₆-C₁₅ aryl group (substituted or unsubstituted); or alternatively, a C₆-C₁₀ aryl group (substituted or unsubstituted). In an embodiment, each R¹, R², R³, and/or R⁴ independently can be a phenyl group, a substituted phenyl group, a naphthyl group, or a substituted naphthyl group. In an embodiment, each R¹, R², R³, and/or R⁴ independently can be a phenyl group or a substituted phenyl group; alternatively, a naphthyl group or a substituted naphthyl group; alternatively, a phenyl group or a naphthyl group; or alternatively, a substituted phenyl group or a substituted naphthyl group.

In an embodiment, each substituted phenyl group which can be utilized as a non-hydrogen R¹, R², R³, and/or R⁴ independently can be a 2-substituted phenyl group, a 3-substituted phenyl group, a 4-substituted phenyl group, a 2,4-disubstituted phenyl group, a 2,6-disubstituted phenyl group, a 3,5-disubstituted phenyl group, or a 2,4,6-trisubstituted phenyl group. In other embodiments, each substituted phenyl group which can be utilized as a non-hydrogen R¹, R², R³, and/or R⁴ independently can be a 2-substituted phenyl group, a 4-substituted phenyl group, a 2,4-disubstituted phenyl group, or a 2,6-disubstituted phenyl group; alternatively, a 3-subsituted phenyl group or a 3,5-disubstituted phenyl group; alternatively, a 2-substituted phenyl group or a 4-substituted phenyl group; alternatively, a 2,4-disubstituted phenyl group or a 2,6-disubstituted phenyl group; alternatively, a 2-substituted phenyl group; alternatively, a 3-substituted phenyl group; alternatively, a 4-substituted phenyl group; alternatively, a 2,4-disubstituted phenyl group; alternatively, a 2,6-disubstituted phenyl group; alternatively, 3,5-disubstituted phenyl group; or alternatively, a 2,4,6-trisubstituted phenyl group. Substituents for the substituted phenyl groups (general or specific) are independently disclosed herein and can be utilized without limitation to further describe the substituted phenyl groups which can be utilized as a non-hydrogen R¹, R², R³, and/or R⁴.

Nonlimiting examples of suitable poly(arylene sulfide) polymers suitable for use in this disclosure include poly(2,4-toluene sulfide), poly(4,4′-biphenylene sulfide), poly(para-phenylene sulfide), poly(ortho-phenylene sulfide), poly(meta-phenylene sulfide), poly(xylene sulfide), poly(ethylisopropylphenylene sulfide), poly(tetramethylphenylene sulfide), poly(butylcyclohexylphenylene sulfide), poly(hexyldodecylphenylene sulfide), poly(octadecyl-phenylene sulfide), poly(phenylphenylene sulfide), poly(tolylphenylene sulfide), poly(benzyl-phenylene sulfide), poly[octyl-4-(3-methylcyclopentyl)phenylene sulfide], and any combination thereof.

In an embodiment the poly(arylene sulfide) polymer comprises poly(phenylene sulfide) or PPS. In an aspect, PPS is a polymer comprising at least about 70, 80, 90, or 95 mole percent para-phenylene sulfide units. In another embodiment, the poly(arylene sulfide) can contain up to about 50, 70, 80, 90, 95, or 99 mole percent para-phenylene sulfide units. In some embodiments, PPS can contain from any minimum mole percent of the para-phenylene sulfide unit disclosed herein to any maximum mole percent of the para-phenylene sulfide unit disclosed herein; for example, from about 70 to about 99 mole percent, alternatively, from about 70 to about 95 mole percent, or alternatively, from about 80 to about 95 mole percent of the —(Ar—S)— unit. Other suitable ranges for the para-phenylene sulfide units will be readily apparent to one of skill in the art with the help of this disclosure. The structure for the para-phenylene sulfide unit can be represented by Formula II.

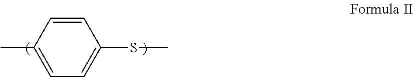

In an embodiment, PPS can comprise up to about 30, 20, 10, or 5 mole percent of one or more units selected from ortho-phenylene sulfide groups, meta-phenylene sulfide groups, substituted phenylene sulfide groups, phenylene sulfone groups, substituted phenylene sulfone groups, or groups having the following structures:

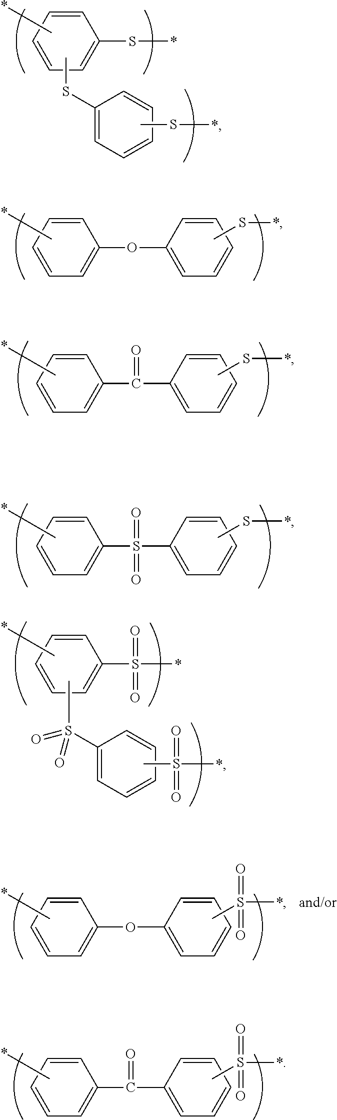

In other embodiments, PPS can comprise up to about 30, 20, 10, or 5 mole percent of units having one or more of the following structures:

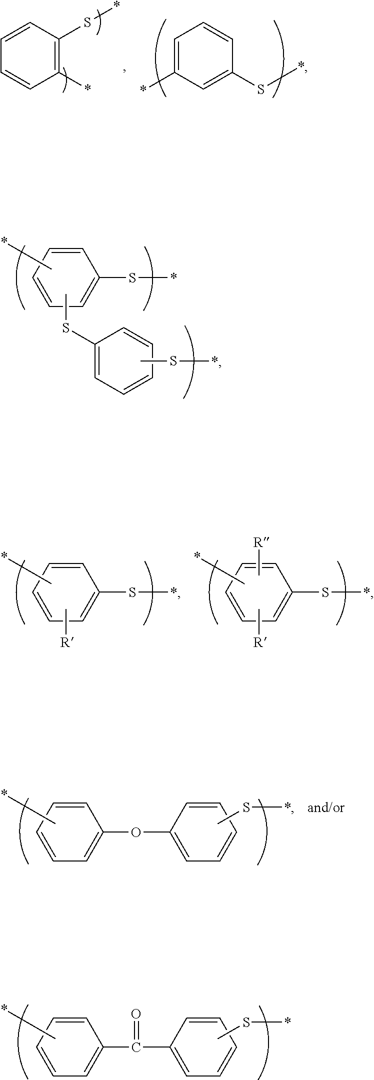

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

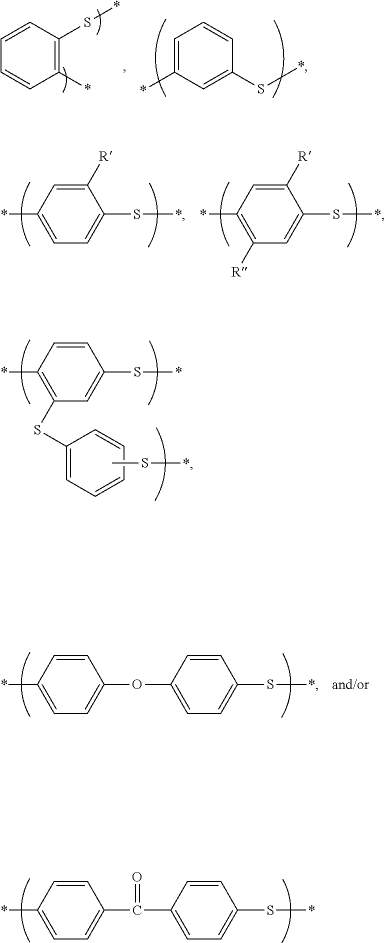

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

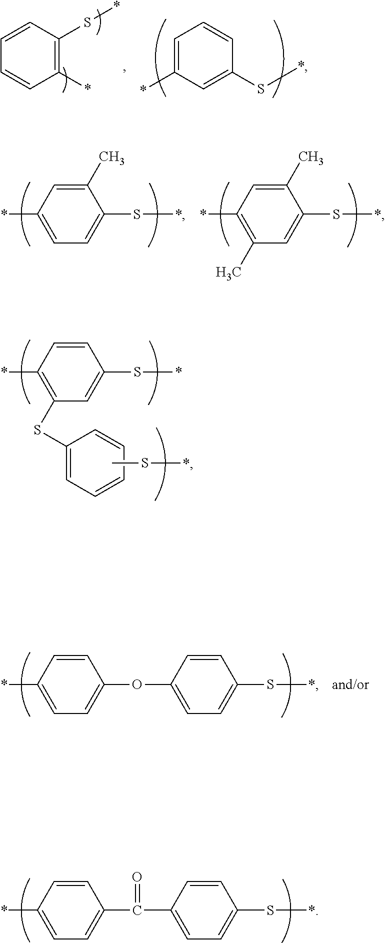

The PPS molecular structure can readily form a thermally stable crystalline lattice, giving PPS a semi-crystalline morphology with a high crystalline melting point ranging from about 265° C. to about 315° C. Because of its molecular structure, PPS also can tend to char during combustion, making the material inherently flame resistant. Further, PPS cannot typically dissolve in solvents at temperatures below about 200° C.

PPS is manufactured and sold under the trade name Ryton® PPS by Chevron Phillips Chemical Company LP of The Woodlands, Tex. Other sources of poly(phenylene sulfide) include Ticona, Toray, and Dainippon Ink and Chemicals, Incorporated, among others.

In an embodiment, the process for producing a poly(arylene sulfide) polymer can comprise a step of polymerizing reactants in a reaction vessel or reactor to produce a poly(arylene sulfide) reaction mixture.

In an embodiment, the step of polymerizing reactants comprises reacting a sulfur source and a dihaloaromatic compound (e.g., a polymerization reaction) in the presence of a polar organic compound to form a reaction mixture (e.g., a polymerization reaction mixture).

In an embodiment, the process for producing a poly(arylene sulfide) polymer comprises reacting a sulfur source and a dihaloaromatic compound in the presence of a polar organic compound to form a reaction mixture (e.g., a poly(arylene sulfide) reaction mixture). In an embodiment, the process for producing a poly(arylene sulfide) polymer comprises polymerizing reactants (e.g., a sulfur source and a dihaloaromatic compound) in a reaction vessel or reactor, to produce a reaction mixture (e.g., a poly(arylene sulfide) reaction mixture), wherein at least a portion of the reactants undergo a polymerization reaction.

Generally, a poly(arylene sulfide) can be produced by contacting at least one halogenated aromatic compound having two halogens, a sulfur compound, and a polar organic compound to form the poly(arylene sulfide). In an embodiment, the process to produce the poly(arylene sulfide) can further comprise recovering the poly(arylene sulfide). In some embodiments, the polyarylene sulfide can be formed under polymerization conditions capable of producing the poly(arylene sulfide). In an embodiment, the poly(arylene sulfide) can be produced in the presence of a halogenated aromatic compound having greater than two halogen atoms (e.g., 1,2,4-trichlorobenzene, among others).

Similarly, PPS can be produced by contacting at least one para-dihalobenzene compound, a sulfur compound, and a polar organic compound to form the PPS. In an embodiment, the process to produce the PPS can further comprise recovering the PPS. In some embodiments, the PPS can be formed under polymerization conditions capable of forming the PPS. When producing PPS, other dihaloaromatic compounds can also be present so long as the produced PPS conforms to the PPS desired features. For example, in an embodiment, the PPS can be prepared utilizing substituted para-dihalobenzene compounds and/or halogenated aromatic compounds having greater than two halogen atoms (e.g., 1,2,4-trichlorobenzene or substituted or a substituted 1,2,4-trichlorobenzene, among others). Methods of PPS production are described in more detail in U.S. Pat. Nos. 3,919,177; 3,354,129; 4,038,261; 4,038,262; 4,038,263; 4,064,114; 4,116,947; 4,282,347; 4,350,810; and 4,808,694; each of which is incorporated by reference herein in its entirety.

In an embodiment, halogenated aromatic compounds having two halogens (e.g., dihaloaromatic compounds) which can be employed to produce the poly(arylene sulfide) can be represented by Formula III.

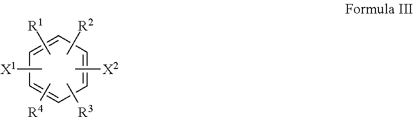

In an embodiment, X¹ and X² independently can be a halogen. In some embodiments, each X¹ and X² independently can be fluorine, chlorine, bromine, iodine; alternatively, chlorine, bromine, or iodine; alternatively, chlorine; alternatively, bromine; or alternatively, iodine. R¹, R², R³ and R⁴ have been described previously herein for the poly(arylene sulfide) having Formula I. Any aspect and/or embodiment of these R¹, R², R³, and R⁴ descriptions can be utilized without limitation to describe the halogenated aromatic compounds having two halogens represented by Formula III. It should be understood, that for producing poly(arylene sulfide)s, the relationship between the position of the halogens X¹ and X² can be ortho, meta, para, or any combination thereof; alternatively, ortho; alternatively, meta; or alternatively, para. Examples of halogenated aromatic compounds having two halogens that can be utilized to produce a poly(arylene sulfide) can include, but not limited to, dichlorobenzene (ortho, meta, and/or para), dibromobenzene (ortho, meta, and/or para), diiodobenzene (ortho, meta, and/or para), chlorobromobenzene (ortho, meta, and/or para), chloroiodobenzene (ortho, meta, and/or para), bromoiodobenzene (ortho, meta, and/or para), dichlorotoluene, dichloroxylene, ethylisopropyldibromobenzene, tetramethyldichlorobenzene, butylcyclohexyldibromobenzene, hexyldodecyldichlorobenzene, octadecyldiidobenzene, phenylchlorobromobenzene, tolyldibromobenzene, benzyldichloro-benzene, octylmethylcyclopentyldichlorobenzene, or any combination thereof.

The para-dihalobenzene compound which can be utilized to produce poly(phenylene sulfide) can be any para-dihalobenzene compound. In an embodiment, para-dihalobenzenes that can be used in the synthesis of PPS can be, comprise, or consist essentially of, p-dichlorobenzene, p-dibromobenzene, p-diiodobenzene, 1-chloro-4-bromobenzene, 1-chloro-4-iodobenzene, 1-bromo-4-iodobenzene, or any combination thereof. In some embodiments, the para-dihalobenzene that can be used in the synthesis of PPS can be, comprise, or consist essentially of, p-dichlorobenzene.

In some embodiments, the synthesis of the PPS can further include 2,5-dichlorotoluene, 2,5-dichloro-p-xylene, 1-ethyl-4-isopropyl-2,5-dibromobenzene, 1,2,4,5-tetramethyl-3,6-dichlorobenzene, 1-butyl-4-cyclohexyl-2,5-dibromobenzene, 1-hexyl-3-dodecyl-2,5-dichlorobenzene, 1-octadecyl-2,5-diidobenzene, 1-phenyl-2-chloro-5-bromobenzene, 1-(p-tolyl)-2,5-dibromobenzene, 1-benzyl-2,5-dichlorobenzene, 1-octyl-4-(3-methylcyclopentyl)-2,5-dichlorobenzene, or combinations thereof.

Without wishing to be limited by theory, sulfur sources which can be employed in the synthesis of the poly(arylene sulfide) can include thiosulfates, thioureas, thioamides, elemental sulfur, thiocarbamates, metal disulfides and oxysulfides, thiocarbonates, organic mercaptans, organic mercaptides, organic sulfides, alkali metal sulfides and bisulfides, hydrogen sulfide, or any combination thereof. In an embodiment, an alkali metal sulfide can be used as the sulfur source. Alkali metal sulfides suitable for use in the present disclosure can be, comprise, or consist essentially of, lithium sulfide, sodium sulfide, potassium sulfide, rubidium sulfide, cesium sulfide, or any combination thereof. In some embodiments, the alkali metal sulfides that can be employed in the synthesis of the poly(arylene sulfide) can be an alkali metal sulfide hydrate or an aqueous alkali metal sulfide solution; alternatively, an alkali metal sulfide hydrate; or alternatively, an aqueous alkali metal sulfide solution. Aqueous alkali metal sulfide solution can be prepared by any suitable methodology. In an embodiment, the aqueous alkali metal sulfide solution can be prepared by the reaction of an alkali metal hydroxide with an alkali metal bisulfide in water; or alternatively, prepared by the reaction of an alkali metal hydroxide with hydrogen sulfide (H₂S) in water. Other sulfur sources suitable for use in the present disclosure are described in more detail in U.S. Pat. No. 3,919,177, which is incorporated by reference herein in its entirety.

In an embodiment, a process for the preparation of poly(arylene sulfide) can utilize a sulfur source which can be, comprise, or consist essentially of, an alkali metal bisulfide. In such embodiments, a reaction mixture for preparation of the poly(arylene sulfide) can comprise a base. In such embodiments, alkali metal hydroxides, such as sodium hydroxide (NaOH) can be utilized. In such embodiments, it can be desirable to reduce the alkalinity of the reaction mixture prior to termination of the polymerization reaction. Without wishing to be limited by theory, a reduction in alkalinity of the reaction mixture can result in the formation of a reduced amount of ash-causing polymer structures. The alkalinity of the reaction mixture can be reduced by any suitable methodology, for example by the addition of an acidic solution prior to termination of the polymerization reaction.

In an embodiment, the sulfur source suitable for use in the production of poly(arylene sulfide) can be prepared by combining sodium hydrosulfide (NaSH) and sodium hydroxide (NaOH) in an aqueous solution followed by dehydration (or alternatively, by combining an alkali metal hydroxide with hydrogen sulfide (H₂S)). The production of Na₂S in this manner can be considered to be an equilibrium between Na₂S, water (H₂O), NaSH, and NaOH according to the following equation.

Na₂S+H₂O [symbol] NaSH+NaOH

The resulting sulfur source can be referred to as sodium sulfide (Na₂S). In another embodiment, the production of Na₂S can be performed in the presence of the polar organic solvent, e.g., N-methyl-2-pyrrolidone (NMP), among others disclosed herein. Without being limited to theory, when the sulfur compound (e.g., sodium sulfide) is prepared by reacting NaSH with NaOH in the presence of water and N-methyl-2-pyrrolidone, the N-methyl-2-pyrrolidone can also react with the sodium hydroxide (e.g., aqueous sodium hydroxide) to produce a mixture containing sodium hydrosulfide and sodium N-methyl-4-aminobutanoate (SMAB). Stoichiometrically, the overall reaction equilibrium can appear to follow the equation:

NMP+Na₂S+H₂O [symbol] CH₃NHCH₂CH₂CH₂CO₂Na(SMAB)+NaSH

However, it should be noted that this equation is a simplification and, in actuality, the equilibrium between Na₂S, H₂O, NaOH, and NaSH, and the water-mediated ring opening of NMP by sodium hydroxide can be significantly more complex.

The polar organic compound which can be utilized in the preparation of a poly(arylene sulfide) can comprise a polar organic compound which can function to keep the dihaloaromatic compounds, sulfur source, and growing poly(arylene sulfide) in solution during the polymerization. In an aspect, the polar organic compound can be, comprise, or consist essentially of, an amide, a lactam, a sulfone, or any combinations thereof; alternatively, an amide; alternatively, a lactam; or alternatively, a sulfone. In an embodiment, the polar organic compound can be, comprise, or consist essentially of, hexamethylphosphoramide, tetramethylurea, N,N-ethylenedipyrrolidone, N-methyl-2-pyrrolidone, pyrrolidone, caprolactam, N-ethylcaprolactam, sulfolane, N,N′-dimethylacetamide, 1,3-dimethyl-2-imidazolidinone, low molecular weight polyamides, or combinations thereof. In an embodiment, the polar organic compound can be, comprise, or consist essentially of, N-methyl-2-pyrrolidone. Additional polar organic compounds suitable for use in the present disclosure are described in more detail in D. R. Fahey and J. F. Geibel, Polymeric Materials Encyclopedia, Vol. 8, (Boca Raton, CRC Press, 1996), pages 6506-6515, which is incorporated by reference herein in its entirety.

In an embodiment, processes for the preparation of a poly(arylene sulfide) can employ one or more additional reagents. For example, molecular weight modifying or enhancing agents such as alkali metal carboxylates, lithium halides, or water can be added or produced during polymerization. In an embodiment, a reaction mixture for preparation of a poly(arylene sulfide) can further comprise an alkali metal carboxylate.

Alkali metal carboxylates which can be employed include, without limitation, those having general formula R′CO₂M where R′ can be a C₁ to C₂₀ hydrocarbyl group, a C₁ to C₂₀ hydrocarbyl group, or a C₁ to C₅ hydrocarbyl group. In some embodiments, R′ can be an alkyl group, a cycloalkyl group, an aryl group, aralkyl group; or alternatively, an alkyl group. Alkyl groups, cycloalkyl groups, aryl groups, aralkyl groups are disclosed herein (e.g., as options for R¹, R², R³, and R⁴ or a substituent groups). These alkyl groups, cycloalkyl groups, aryl groups, aralkyl groups can be utilized without limitation to further describe R′ of the alkali metal carboxylates having the formula R′CO₂M. In an embodiment, M can be an alkali metal. In some embodiments, the alkali metal can be, comprise, or consist essentially of, lithium, sodium, potassium, rubidium, or cesium; alternatively, lithium; alternatively, sodium; or alternatively, potassium. The alkali metal carboxylate can be employed as a hydrate; or alternatively, as a solution or dispersion in water. In an embodiment, the alkali metal carboxylate can be, comprise, or consist essentially of, sodium acetate (NaOAc or NaC₂H₃O₂).

Generally, the ratio of reactants employed in the polymerization process to produce a poly(arylene sulfide) can vary widely. However, the typical equivalent ratio of the halogenated aromatic compound having two halogens to sulfur compound can be in the range of from about 0.8 to about 2; alternatively, from about 0.9 to about 1.5; or alternatively, from about 0.95 to about 1.3. The amount of polyhalo-substituted aromatic compound (e.g., trihaloaromatic compound) optionally employed as a reactant can be any amount to achieve a desired degree of branching to give a desired poly(arylene sulfide) melt flow. Generally, up to about 0.02 mole of polyhalo-substituted aromatic compound per mole of halogenated aromatic compound having two halogens can be employed. As will be appreciated by one of skill in the art, and with the help of this disclosure, generally, the flow properties of a polymer (e.g., melt flow, flow rate, etc.) correlate with the degree of branching (e.g., the use of a polyhalo-substituted aromatic compound could cause branching and lower the flow rate). If an alkali metal carboxylate is employed as a molecular weight modifying agent, the mole ratio of alkali metal carboxylate to dihaloaromatic compound(s) can be within the range of from about 0.02 to about 4; alternatively, from about 0.05 to about 3; or alternatively, from about 0.1 to about 2.

The amount of polar organic compound employed in the process to prepare the poly(arylene sulfide) can vary over a wide range during the polymerization. However, the molar ratio of polar organic compound to the sulfur compound is typically within the range of from about 1 to about 10. If a base, such as sodium hydroxide, is contacted with the polymerization reaction mixture, the molar ratio is generally in the range of from about 0.5 to about 4 moles per mole of sulfur compound.

General conditions for the production of poly(arylene sulfides) are generally described in U.S. Pat. Nos. 5,023,315; 5,245,000; 5,438,115; and 5,929,203; each of which is incorporated by reference herein in its entirety. Although specific mention can be made in this disclosure and the disclosures incorporated by reference herein to material produced using the “quench” termination process, it is contemplated that other processes (e.g., “flash” termination process) can be employed for the preparation of a poly(arylene sulfide) (e.g., PPS). It is contemplated that a poly(arylene sulfide) obtained from a process other than the quench termination process can be suitably employed in the methods and compositions of this disclosure. As will be appreciated by one of skill in the art and with the help of this disclosure, a “termination process” refers to a process by which a polymerization reaction (e.g., a polymerization reaction yielding a poly(arylene sulfide) polymer) is terminated (e.g., stopped, ceased, finished, concluded, ended, completed, finalized, etc.). Further, as will be appreciated by one of skill in the art and with the help of this disclosure, a polymerization reaction can be considered “terminated” when polymerization is substantially complete or when further reaction would not result in a significant increase in polymer molecular weight.

The components of the reaction mixture can be contacted with each other in any order. Some of the water, which can be introduced with the reactants, can be removed prior to polymerization. In some instances, the water can be removed in a dehydration process. For example, in instances where a significant amount of water is present (e.g., more than about 0.3 mole of water per mole of sulfur compound) water can be removed in a dehydration process. The temperature at which the polymerization can be conducted can be within the range of from about 170° C. (347° F.) to about 450° C. (617° F.); or alternatively, within the range of from about 200° C. (392° F.) to about 285° C. (545° F.). The reaction time can vary widely, depending, in part, on the reaction temperature, but is generally within the range of from about 10 minutes to about 3 days; or alternatively, within a range of from about 1 hour to about 8 hours. The reactor pressure need be only sufficient to maintain the polymerization reaction mixture substantially in the liquid phase. Such pressure can be in the range of from about 0 psig to about 400 psig; alternatively, in the range of from about 30 psig to about 300 psig; or alternatively, in the range of from about 100 psig to about 250 psig.

The polymerization can be terminated (e.g., quenched) by cooling the reaction mixture (removing heat) to a temperature below that at which substantial polymerization takes place. In some instances the cooling of the reaction mixture can also begin the process to recover the poly(arylene sulfide) as the poly(arylene sulfide) can precipitate from solution at temperatures less than about 235° C. Depending upon the polymerization features (temperature, solvent(s), and water quantity, among other features) and the methods employed to cool the reaction mixture, the poly(arylene sulfide) can begin to precipitate from the reaction solution at a temperature ranging from about 235° C. to about 185° C. Generally, poly(arylene sulfide) precipitation can impede further polymerization.

In some embodiments, the polymerization can be terminated by the flash evaporation of the solvent (e.g., the polar organic compound, water, or a combination thereof) from the poly(arylene sulfide) reaction mixture. Processes for preparing poly(arylene sulfide) utilizing solvent flash evaporation to terminate the reaction can be referred to as a flash termination process. In other embodiments, the polymerization can be terminated by adding a liquid (e.g., a quench liquid) comprising, or consisting essentially of, 1) water, 2) polar organic compound, or 3) a combination of water and polar organic compound (alternatively water; or alternatively, polar organic compound) to the poly(arylene sulfide) reaction mixture and cooling the poly(arylene sulfide) reaction mixture. In yet other embodiments, the polymerization can be terminated by adding a solvent(s) other than water or the polar organic compound to the poly(arylene sulfide) reaction mixture and cooling the poly(arylene sulfide) reaction mixture. A process for preparing poly(arylene sulfide) which utilizes the addition of water, polar organic compound, and/or other solvent(s) to terminate the reaction can be referred to as a quench termination process. The cooling of the reaction mixture can be facilitated by the use of reactor jackets or coils. Another method for terminating the polymerization can include contacting the reaction mixture with a polymerization inhibiting compound. It should be noted that termination of the polymerization does not imply that complete reaction of the polymerization components has occurred. Moreover, termination of the polymerization is not meant to imply that no further polymerization of the reactants can take place. Generally, for economic reasons, termination (and poly(arylene sulfide) recovery) can be initiated at a time when polymerization is substantially complete or when further reaction would not result in a significant increase in polymer molecular weight.

In an embodiment, the process for producing a poly(arylene sulfide) polymer is a quench process comprising a quench step. In an embodiment, the quench step comprises quenching the reaction mixture (e.g., quenching the polymerization reaction) with a quench liquid, wherein the quench liquid can comprise a by-product treatment additive.

In an embodiment, a process for producing a poly(arylene sulfide) polymer can comprise a step of processing at least a portion of the poly(arylene sulfide) reaction mixture to obtain a poly(arylene sulfide) reaction mixture downstream product, wherein processing the poly(arylene sulfide) reaction mixture can comprise quenching the reaction mixture by adding a quench liquid thereto. In such embodiment, the quench liquid can comprise a by-product treatment additive. In an embodiment, the process for producing a poly(arylene sulfide) polymer can comprise a step of quenching the polymerization reaction by adding a quench liquid to the reaction mixture (e.g., to the reaction vessel), wherein the quench liquid can comprise a by-product treatment additive. As will be appreciated by one of skill in the art and with the help of this disclosure, the reaction cycle ends or the quench cycle begins when polymerization is substantially complete or when further reaction would not result in a significant increase in polymer molecular weight. For example, in a quench step, a quench liquid can be added to the poly(arylene sulfide) reaction mixture and a temperature of the poly(arylene sulfide) reaction mixture can be lowered, thereby causing the polymer to precipitate out the solution (e.g., no further significant increase in polymer molecular weight). Further, as will be appreciated by one of skill in the art and with the help of this disclosure, the timing for ending the reaction cycle or beginning the quench cycle can be determined by monitoring process parameters such as for example time, temperature, and/or pressure.

In an embodiment, the quench liquid can comprise water, a polar organic compound, or combinations thereof.

In an embodiment, the by-product treatment additive comprises an acid, a non-oxidizing acid, an organic acid, a mineral acid, an acid precursor, a salt, and the like, or combinations thereof. For purposes of the disclosure herein, an acid precursor can be defined as a material or combination of materials that provides for the release (e.g., delayed release) of one or more acidic species. Acid precursors can comprise a material or combination of materials that could react to generate and/or liberate an acid. The liberation of acidic species from the acid precursor can be accomplished through any means known to one of ordinary skill in the art with the benefits of this disclosure and compatible with user-desired applications.

Nonlimiting examples of by-product treatment additives suitable for use in the present disclosure include acetic acid, propionic acid, formic acid, hydrochloric acid, carbon dioxide, dry ice, sodium carbonate, sodium bicarbonate, potassium carbonate, potassium bicarbonate, sodium acetate, potassium acetate, acid containing clays, silica, and the like, or combinations thereof.

In an embodiment, the by-product treatment additive does not contain a material amount of an oxidizing acid and/or an oxidizing acid precursor. In an embodiment, the by-product treatment additive contains only trace amounts of an oxidizing acid and/or an oxidizing acid precursor, based on detection limits of commercially available equipment (e.g., gas chromatograph, mass spectrometer, etc.). In an embodiment, the by-product treatment additive comprises an oxidizing acid and/or an oxidizing acid precursor in an amount of less than about 1 wt. %, alternatively less than about 0.5 wt. %, alternatively less than about 0.1 wt. %, alternatively less than about 0.01 wt. %, alternatively less than about 0.001 wt. %, or alternatively less than about 0.0001 wt. %, based on the weight of the by-product treatment additive. For purposes of the disclosure herein, an oxidizing acid precursor can be defined as a material or combination of materials that provides for the release (e.g., delayed release) of one or more oxidizing acidic species. Nonlimiting examples of oxidizing acids and/or an oxidizing acid precursors include nitric acid, perchloric acid, chloric acid, chromic acid, sulfuric acid, conjugated salts thereof, and the like, or combinations thereof.

In an embodiment, the quench liquid can comprise water and/or a polar organic compound. In such embodiment, the by-product treatment additive can be added to the reaction mixture (e.g., to the reaction vessel) as a solution, slurry and/or dispersion in the quench liquid. In some embodiments, the by-product treatment additive can be added to the reaction mixture (e.g., to the reaction vessel) as a solid (e.g., powder, crystals, hydrates, etc.).

In an embodiment, a process for producing a poly(arylene sulfide) polymer can comprise a step of cooling the reaction mixture to yield poly(arylene sulfide) polymer particles (e.g., step of cooling the reaction vessel containing the reaction mixture). In an embodiment, the step of cooling the reaction vessel containing the reaction mixture can begin prior to, concurrent with, and/or subsequent to the step of quenching the reaction mixture (e.g., quenching the polymerization reaction). In an embodiment, cooling the reaction mixture (e.g., cooling the reaction vessel containing the reaction mixture) can be a ramped cooling process, wherein the temperature is decreased or lowered in a controlled fashion over time.

In an embodiment, cooling the reaction mixture (e.g., cooling the reaction vessel containing the reaction mixture) can comprise the use of external cooling; jacket cooling; internal cooling; adding a liquid (e.g., quench liquid) to the reaction vessel, wherein the temperature of the quench liquid is lower than the temperature of the reaction mixture (e.g., the temperature inside the reaction vessel); and the like; or combinations thereof.

In an embodiment, cooling the reaction mixture (e.g., cooling the reaction vessel containing the reaction mixture) can cause at least a portion of the poly(arylene sulfide) polymer to precipitate from solution (e.g., reaction mixture), thereby forming a particulate poly(arylene sulfide) (e.g., poly(arylene sulfide) polymer particles). As will be appreciated by one of skill in the art, and with the help of this disclosure, the lower the temperature (e.g., a temperature of the reaction mixture, a temperature inside the reaction vessel), the less soluble the poly(arylene sulfide) polymer.

In an embodiment, a process for producing a poly(arylene sulfide) polymer can comprise a step of processing at least a portion of the poly(arylene sulfide) reaction mixture to obtain a poly(arylene sulfide) reaction mixture downstream product, wherein processing the poly(arylene sulfide) reaction mixture can comprise (i) washing the poly(arylene sulfide) reaction mixture with a polar organic compound and/or water to obtain a poly(arylene sulfide) polymer (e.g., washed poly(arylene sulfide) polymer) and a poly(arylene sulfide) reaction mixture downstream product (e.g., first slurry); (ii) treating at least a portion of the poly(arylene sulfide) polymer with an aqueous acid solution and/or an aqueous metal cation solution to obtain a treated poly(arylene sulfide) polymer and a waste aqueous solution; (iii) drying at least a portion of the poly(arylene sulfide) polymer and/or treated poly(arylene sulfide) polymer to obtain a dried poly(arylene sulfide) polymer; and (iv) evaporating a portion of the first slurry to obtain a by-product slurry, wherein the by-product slurry can comprise slurry particulates.

In an embodiment, a process for producing a poly(arylene sulfide) polymer can comprise a step of washing at least a portion of the poly(arylene sulfide) reaction mixture with a polar organic compound and/or water to obtain a poly(arylene sulfide) polymer (e.g., washed poly(arylene sulfide) polymer) and a poly(arylene sulfide) reaction mixture downstream product. In such embodiment, the poly(arylene sulfide) reaction mixture downstream product can comprise a first slurry. In an embodiment, a washing vessel can receive at least a portion of the poly(arylene sulfide) reaction mixture (e.g., the poly(arylene sulfide) reaction mixture can be introduced to a washing vessel), wherein the poly(arylene sulfide) reaction mixture can be washed with a polar organic compound and/or water (e.g., simultaneously or sequentially) to obtain a poly(arylene sulfide) polymer and a poly(arylene sulfide) reaction mixture downstream product (e.g., a first slurry). As will be appreciated by one of skill in the art, more than one washing vessel can be used for washing the poly(arylene sulfide) reaction mixture, such as for example two, three, four, five, six, or more washing vessels can be used for washing the poly(arylene sulfide) reaction mixture.

In some embodiments, a by-product treatment additive can be contacted with at least a portion of the poly(arylene sulfide) reaction mixture prior to, concurrent with, and/or subsequent to the step of washing the poly(arylene sulfide) reaction mixture with a polar organic compound and/or water.

In an embodiment, the by-product treatment additive can be contacted with at least a portion of the poly(arylene sulfide) reaction mixture concurrent with the step of washing the poly(arylene sulfide) reaction mixture with a polar organic compound and/or water. In such embodiment, the by-product treatment additive can be contacted with the poly(arylene sulfide) reaction mixture as a solution, slurry and/or dispersion in the polar organic compound and/or water used for the washing step. In some embodiments, the by-product treatment additive can be contacted with the poly(arylene sulfide) reaction mixture as a solid (e.g., powder, crystals, hydrates, etc.).

Once the poly(arylene sulfide) has precipitated from solution, a particulate poly(arylene sulfide) can be separated (e.g., recovered, retrieved, obtained, etc.) from the poly(arylene sulfide) reaction mixture (e.g., poly(arylene sulfide) reaction mixture slurry) by any process capable of separating a solid precipitate from a liquid. For purposes of the disclosure herein, the particulate poly(arylene sulfide) separated from the poly(arylene sulfide) reaction mixture will be referred to as “poly(arylene sulfide) polymer particles,” “poly(arylene sulfide) particles,” “particulate poly(arylene sulfide) polymer,” “particulate poly(arylene sulfide),” “poly(arylene sulfide) polymer,” or simply “poly(arylene sulfide).” For purposes of the disclosure herein, poly(arylene sulfide) polymer particles can also be referred to as “raw particulate poly(arylene sulfide) polymer,” “raw particulate poly(arylene sulfide),” “raw poly(arylene sulfide) polymer particles,” “raw poly(arylene sulfide) particles,” “raw poly(arylene sulfide) polymer,” or simply “raw poly(arylene sulfide),” (e.g., “raw PPS”) where further processing steps are contemplated after separation of the polymer particles from the poly(arylene sulfide) reaction mixture.

Procedures which can be utilized to separate the poly(arylene sulfide) polymer particles from the reaction mixture slurry can include, but are not limited to, i) filtration, ii) washing the poly(arylene sulfide) polymer particles with a liquid (e.g., water or aqueous solution), or iii) dilution of the reaction mixture with liquid (e.g., water or aqueous solution) followed by filtration and washing the poly(arylene sulfide) polymer particles with a liquid (e.g., water or aqueous solution). In an embodiment, the poly(arylene sulfide) polymer can be separated from the poly(arylene sulfide) reaction mixture by way of a screening process, e.g., passing the poly(arylene sulfide) reaction mixture through a screen (e.g., sieve, mesh, wire screen, wire sieve, wire mesh, etc.), wherein the poly(arylene sulfide) polymer is retained on the screen (e.g., recovered poly(arylene sulfide) polymer).

In an embodiment, in addition to the poly(arylene sulfide) polymer recovered as a solid phase, the procedures utilized to recover the poly(arylene sulfide) polymer from the reaction mixture can also yield a liquid phase comprising both dissolved compounds and suspended or slurried particles (e.g., polymer impurities), as will be discussed in more detail later herein. For purposes of the disclosure herein, such liquid phase will be referred to as “first slurry.” In an embodiment, a tank can receive at least a portion of the first slurry (e.g., the first slurry can be introduced to a tank), wherein the first slurry can be stored prior to further processing.

It should be noted that the process to produce the poly(arylene sulfide) can form a by-product alkali metal halide. The by-product alkali metal halide can be separated from the poly(arylene sulfide) polymer during process steps utilized to separate the poly(arylene sulfide) polymer particles and the first slurry. Generally, the by-product alkali metal halide will be found (e.g., recovered, retrieved, etc.) in the first slurry as dissolved by-product alkali metal halide, slurried by-product alkali metal halide particles, or combinations thereof, based on the solubility of the by-product alkali metal halide in the first slurry, as will be discussed in more detail later herein.

In a non-limiting embodiment, the reaction mixture slurry can be filtered to separate impure poly(arylene sulfide) polymer particles (containing poly(arylene sulfide) or PPS, and by-product alkali metal halide). The impure poly(arylene sulfide) polymer particles can be slurried in a liquid (e.g., water or aqueous solution) and subsequently filtered to remove the alkali metal halide by-product (and/or other liquid, e.g., water, soluble impurities) into the first slurry and to yield purified poly(arylene sulfide) polymer particles. For brevity these purified polymer particles are referred to herein as “poly(arylene sulfide) polymer particles.” As will be appreciated by one of skill in the art, and with the help of this disclosure, during the filtration process to remove the alkali metal halide by-product (and/or other liquid, e.g., water, soluble impurities) into the first slurry, the poly(arylene sulfide) polymer particles are generally retained on the filter (e.g., sieve, screen, etc.), while the alkali metal halide by-product will pass through the filter as dissolved by-product alkali metal halide, slurried by-product alkali metal halide particles, or combinations thereof, as the by-product alkali metal halide particles generally have a smaller size when compared to a size of the poly(arylene sulfide) polymer particles. Generally, the steps of slurrying the poly(arylene sulfide) polymer particles with a liquid followed by filtration to separate the poly(arylene sulfide) polymer particles can occur as many times as necessary to obtain a desired level of purity of the poly(arylene sulfide) polymer, by removing the alkali metal halide by-product (and/or other liquid, e.g., water, soluble impurities, polymer impurities, etc.) into the first slurry.

In an embodiment, the first slurry can comprise water, a polar organic compound (e.g., NMP), an alkali metal halide by-product (e.g., salt, NaCl), poly(arylene sulfide) polymer impurities (e.g., poly(arylene sulfide) fines, poly(arylene sulfide) oligomers, poly(arylene sulfide) low molecular weight polymers, polymerization reaction side-products, polymerization reaction by-products), a halogenated aromatic compound (e.g., p-dichlorobenzene), a molecular weight modifying agent (e.g., an alkali metal carboxylate, sodium acetate), and other impurities. As will be appreciated by one of skill in the art, and with the help of this disclosure, while the first slurry is the liquid phase obtained during one or more filtration processes to recover the poly(arylene sulfide), some insoluble particulates (e.g., polymer fines, by-product alkali metal halide particles) can pass through a filtering device (e.g., a filter, a screen, a sieve) and be present in such liquid phase (e.g., filtrate), thereby making the liquid phase a slurry. Further, as will be appreciated by one of skill in the art, and with the help of this disclosure, the first slurry can be a very diluted slurry, based on the amount of liquid present in the reaction mixture and the amount of liquid used to wash the particulate poly(arylene sulfide) during the recovery of the poly(arylene sulfide). Further, as will be appreciated by one of skill in the art, and with the help of this disclosure, the amount and type of liquid present in the first slurry influences the solubility of components of the first slurry, and some slurry components (e.g., salts, NaCl, alkali metal carboxylates, sodium acetate) can be partially soluble in the first slurry, e.g., a portion of a slurry component can be present in the first slurry as a dissolved component, while another portion of the same slurry component can be present in the first slurry as a solid particle.

In an embodiment, the first slurry can be subjected to further processing, such as for example to recover the polar organic compound, as will be described in detail later herein. The recovered polar organic compound (e.g., recovered NMP) can be recycled/reused in a subsequent polymerization process for the production of poly(arylene sulfide) (e.g., PPS).

In an embodiment, a process for producing a poly(arylene sulfide) polymer can optionally comprise a step of treating at least a portion of the poly(arylene sulfide) polymer (e.g., poly(arylene sulfide) polymer particles) with an aqueous acid solution and/or an aqueous metal cation solution to obtain a treated poly(arylene sulfide) polymer, wherein the treated poly(arylene sulfide) polymer can be recovered from a treatment solution via a separation (e.g., filtration) step.

In an embodiment, the poly(arylene sulfide) polymer can be treated with an aqueous acid solution and/or can be treated with an aqueous metal cation solution, to yield treated poly(arylene sulfide) (e.g., acid treated poly(arylene sulfide) and/or metal cation treated poly(arylene sulfide)). Additionally, the poly(arylene sulfide) polymer can be dried to remove liquid adhering to the poly(arylene sulfide) polymer particles. Generally, the poly(arylene sulfide) polymer which can be treated can be i) the poly(arylene sulfide) polymer particles separated from the reaction mixture or ii) the poly(arylene sulfide) polymer particles which have been washed with a liquid (e.g., water) and filtered to remove the alkali metal halide by-product (and/or other liquid soluble impurities). The poly(arylene sulfide) polymer particles which can be treated can either be liquid wet or dry; alternatively, liquid wet; or alternatively, dry.

Acid treatment can comprise a) contacting the poly(arylene sulfide) with water to form a poly(arylene sulfide) slurry, b) contacting the poly(arylene sulfide) slurry with an acidic compound to form an acidic mixture, c) heating the acidic mixture in the substantial absence of a gaseous oxidizing atmosphere to an elevated temperature below the melting point of the poly(arylene sulfide), and d) recovering an acid treated poly(arylene sulfide) (e.g., an acid treated PPS); or alternatively, a) contacting the poly(arylene sulfide) with an aqueous solution comprising an acidic compound to form an acidic mixture, b) heating the acidic mixture in the substantial absence of a gaseous oxidizing atmosphere to an elevated temperature below the melting point of the poly(arylene sulfide), and c) recovering an acid treated poly(arylene sulfide) (e.g., acid treated PPS). The acidic compound can be any organic acid or inorganic acid which is water soluble under the conditions of the acid treatment; alternatively, an organic acid which is water soluble under the conditions of the acid treatment; or alternatively, an inorganic acid which is water soluble under the conditions of the acid treatment. Generally, the organic acid which can be utilized in the acid treatment can be any organic acid which is water soluble under the conditions of the acid treatment. In an embodiment, the organic acid which can be utilized in the acid treatment process can comprise, or consist essentially of, a C₁ to C₁₅ carboxylic acid; alternatively, a C₁ to C₁₀ carboxylic acid; or alternatively, a C₁ to C₅ carboxylic acid. In an embodiment, the organic acid which can be utilized in the acid treatment process can comprise, or consist essentially of, acetic acid, formic acid, oxalic acid, fumaric acid, and monopotassium phthalic acid; alternatively, acetic acid; alternatively, formic acid; alternatively, oxalic acid; or alternatively, fumaric acid. Inorganic acids which can be utilized in the acid treatment process can comprise, or consist essentially of, hydrochloric acid, monoammonium phosphate, sulfuric acid, phosphoric acid, boric acid, nitric acid, sodium dihydrogen phosphate, ammonium dihydrogen phosphate, carbonic acid, and sulfurous acid; alternatively, hydrochloric acid; alternatively, sulfuric acid; alternatively, phosphoric acid; alternatively, boric acid; or alternatively, nitric acid. The amount of the acidic compound present in the mixture (e.g., acidic mixture) can range from 0.01 wt. % to 10 wt. %, from 0.025 wt. % to 5 wt. %, or from 0.075 wt. % to 1 wt. % based on total amount of water in the mixture (e.g., acidic mixture). The amount of poly(arylene sulfide) present in the mixture (e.g., acidic mixture) can range from about 1 wt. % to about 50 wt. %, from about 5 wt. % to about 40 wt. %, or from about 10 wt. % to about 30 wt. %, based upon the total weight of the mixture (e.g., acidic mixture). Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide); or alternatively, can range from about 175° C. to about 275° C., or from about 200° C. to about 250° C. Additional features of the acid treatment process are described in more detail in U.S. Pat. No. 4,801,664, which is incorporated by reference herein in its entirety.

Generally, the metal cation treatment can comprise a) contacting the poly(arylene sulfide) with water to form a poly(arylene sulfide) slurry, b) contacting the poly(arylene sulfide) slurry with a Group 1 or Group 2 metal compound to form a metal cation mixture, c) heating the metal cation mixture in the substantial absence of a gaseous oxidizing atmosphere to an elevated temperature below the melting point of the poly(arylene sulfide), and d) recovering a metal cation treated poly(arylene sulfide) (e.g., metal cation treated PPS); or alternatively, a) contacting the poly(arylene sulfide) with an aqueous solution comprising a Group 1 or Group 2 metal compound to form a metal cation mixture, b) heating the metal cation mixture in the substantial absence of a gaseous oxidizing atmosphere to an elevated temperature below the melting point of the poly(arylene sulfide), and c) recovering a metal cation treated poly(arylene sulfide) (e.g., metal cation treated PPS). The Group 1 or Group 2 metal compound can be any organic Group 1 or Group 2 metal compound or inorganic Group 1 or Group 2 metal compound which is water soluble under the conditions of the metal cation treatment; alternatively, an organic Group 1 or Group 2 metal compound which is water soluble under the conditions of the metal cation treatment; or alternatively, an inorganic Group 1 or Group 2 metal compound which is water soluble under the conditions of the metal cation treatment. Organic Group 1 or Group 2 metal compounds which can be utilized in the metal cation treatment process can comprise, or consist essentially of, a Group 1 or Group 2 metal C₁ to C₁₅ carboxylate; alternatively, a Group 1 or Group 2 metal C₁ to C₁₀ carboxylate; or alternatively, a Group 1 or Group 2 metal C₁ to C₅ carboxylate (e.g., formate, acetate). Inorganic Group 1 or Group 2 metal compounds which can be utilized in the metal cation treatment process can comprise, or consist essentially of, a Group 1 or Group 2 metal oxide or hydroxide (e.g., calcium oxide or calcium hydroxide). The amount of the Group 1 or Group 2 metal compound present in the mixture (e.g., metal cation mixture) can range from about 50 ppm to about 10,000 ppm, from about 75 ppm to about 7,500 ppm, or from about 100 ppm to about 5,000 ppm. Generally, the amount of the Group 1 or Group 2 metal compound is by the total weight of the mixture (e.g., metal cation mixture). The amount of poly(arylene sulfide) present in the mixture (e.g., metal cation mixture) can range from about 10 wt. % to about 60 wt. %, from about 15 wt. % to about 55 wt. %, or from about 20 wt. % to about 50 wt. %, based upon the total weight of the mixture (e.g., metal cation mixture). Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide); or alternatively, can range from about 125° C. to about 275° C., or from about 150° C. to about 250° C. Additional features of the metal cation treatment process are provided in U.S. Pat. No. 4,588,789, which is incorporated by reference herein in its entirety.

Once the poly(arylene sulfide) has been acid treated and/or metal cation treated, the acid treated and/or metal cation treated poly(arylene sulfide) can be separated from a treatment solution via a filtration step, to yield a treated poly(arylene sulfide) polymer and a waste aqueous solution. Generally, the process/steps for recovering the acid treated and/or metal cation treated poly(arylene sulfide) can be the same steps as those for separating and/or isolating the poly(arylene sulfide) polymer particles from the reaction mixture. The waste aqueous solution can be discarded or disposed of.

Once the poly(arylene sulfide) polymer particles have been recovered (either in raw, acid treated, metal cation treated, or acid treated and metal cation treated form), the poly(arylene sulfide) can be dried and optionally cured. In an embodiment, a process for producing a poly(arylene sulfide) polymer can comprise a step of drying at least a portion of the poly(arylene sulfide) polymer particles to obtain a dried poly(arylene sulfide) polymer.

Generally, the poly(arylene sulfide) drying process can be performed at any temperature which can substantially dry the poly(arylene sulfide), to yield a dried poly(arylene sulfide) polymer. Preferably, a drying process should result in substantially no oxidative curing of the poly(arylene sulfide). For example, if the drying process is conducted at a temperature of or above about 100° C., the drying should be conducted in a substantially non-oxidizing atmosphere (e.g., in a substantially oxygen free atmosphere or at a pressure less than atmospheric pressure, for example under vacuum). When the drying process is conducted at a temperature below about 100° C., the drying process can be facilitated by performing the drying at a pressure less than atmospheric pressure so the liquid component can be vaporized from the poly(arylene sulfide). When the poly(arylene sulfide) drying is performed below about 100° C., the presence of a gaseous oxidizing atmosphere will generally not result in a detectable curing of the poly(arylene sulfide). Generally, air is considered to be a gaseous oxidizing atmosphere.

Poly(arylene sulfide) can be cured by subjecting the poly(arylene sulfide) polymer particles to an elevated temperature, below its melting point, in the presence of gaseous oxidizing atmosphere, thereby forming cured poly(arylene sulfide) polymer (e.g., cured PPS). Any suitable gaseous oxidizing atmosphere can be used. For example, suitable gaseous oxidizing atmospheres include, but are not limited to, oxygen, any mixture of oxygen and an inert gas (e.g., nitrogen), or air; or alternatively air. The curing temperature can range from about 1° C. to about 130° C. below the melting point of the poly(arylene sulfide), from about 10° C. to about 110° C. below the melting point of the poly(arylene sulfide), or from about 30° C. to about 85° C. below the melting point of the poly(arylene sulfide). Agents that affect curing, such as peroxides, accelerants, and/or inhibitors, can be incorporated into the poly(arylene sulfide).

In an aspect, the poly(arylene sulfide) polymer described herein can further comprise one or more additives. In an embodiment, the poly(arylene sulfide) polymer can ultimately be used or blended in a compounding process, for example, with various additives, such as polymers, fillers, fibers, reinforcing materials, pigments, nucleating agents, antioxidants, ultraviolet (UV) stabilizers (e.g., UV absorbers), lubricants, fire retardants, heat stabilizers, carbon black, plasticizers, corrosion inhibitors, mold release agents, pigments, titani r de, clay, mica, processing aids, adhesives, tackifiers, and the like, or combinations thereof.

In an embodiment, fillers which can be utilized include, but are not limited to, mineral fillers, inorganic fillers, or organic fillers, or mixtures thereof. In some embodiments, the filler can comprise, or consist essentially of, a mineral filler; alternatively, an inorganic filler; or alternatively, an organic filler. In an embodiment, mineral fillers which can be utilized include, but are not limited to, glass fibers, milled fibers, glass beads, asbestos, wollastonite, hydrotalcite, fiberglass, mica, talc, clay, calcium carbonate, magnesium hydroxide, silica, potassium titanate fibers, rockwool, or any combination thereof; alternatively, glass fibers; alternatively, glass beads; alternatively, asbestos; alternatively, wollastonite; alternatively, hydrotalcite; alternatively, fiberglass; alternatively, silica; alternatively, potassium titanate fibers; or alternatively, rockwool. Exemplary inorganic fillers can include, but are not limited to, aluminum flakes, zinc flakes, fibers of metals such as brass, aluminum, zinc, or any combination thereof; alternatively, aluminum flakes; alternatively, zinc flakes; or alternatively, fibers of metals such as brass, aluminum, and zinc. Exemplary organic fillers can include, but are not limited to, carbon fibers, carbon black, graphene, graphite, a fullerene, a buckyball, a carbon nanofiber, a carbon nanotube, or any combination thereof; alternatively, carbon fibers; alternatively, carbon black; alternatively, graphene; alternatively, graphite; alternatively, a fullerene; alternatively, a buckyball; alternatively, a carbon nanofiber; or alternatively, a carbon nanotube. Fibers such as glass fibers, milled fibers, carbon fibers and potassium titanate fibers, and inorganic fillers such as mica, talc, and clay can be incorporated into the composition, which can provide molded articles to provide a composition which can have improved properties.

In an embodiment, pigments which can be utilized include, but are not limited to, titanium dioxide, zinc sulfide, or zinc oxide, and mixtures thereof.

In an embodiment, UV absorbers which can be utilized include, but are not limited to, oxalic acid diamide compounds or sterically hindered amine compounds, and mixtures thereof.

In an embodiment, lubricants which can be utilized include, but are not limited to, polyaphaolefins, polyethylene waxes, polyethylene, high density polyethylene (HDPE), polypropylene waxes, and paraffins, and mixtures thereof.

In an embodiment, the fire retardant can be a phosphorus based fire retardant, a halogen based fire retardant, a boron based fire retardant, an antimony based fire retardant, an amide based fire retardant, or any combination thereof. In an embodiment, phosphorus based fire retardants which can be utilized include, but are not limited to, triphenyl phosphate, tricresyl phosphate, a phosphate obtained from a mixture of isopropylphenol and phenol and phosphorus oxychloride, or phosphate esters obtained from difunctional phenols (e.g., benzohydroquinone or bisphenol A), an alcohol, or a phenol and phosphorus oxychloride; alternatively, triphenyl phosphate; alternatively, tricresyl phosphate; alternatively, a phosphate obtained from a mixture of isopropylphenol and phenol and phosphorus oxychloride; or alternatively, phosphate esters obtained from difunctional phenols (e.g., benzohydroquinone or bisphenol A), an alcohol, or a phenol and phosphorus oxychloride. In an embodiment, halogen based fire retardants which can be utilized include, but are not limited to, brominated compounds. In some embodiments, the halogen based fire retardants which can be utilized include, but are not limited to, decabromobiphenyl, pentabromotoluene, decabromobiphenyl ether, hexabromobenzene, or brominated polystyrene. In an embodiment, stabilizers which can be utilized include, but are not limited to, sterically hindered phenols and phosphite compounds.

In an aspect, the poly(arylene sulfide) described herein can further be processed by melt processing. In an embodiment, melt processing can generally be any process, step(s) which can render the poly(arylene sulfide) in a soft or “moldable state.” In an embodiment, the melt processing can be a step wherein at least part of the polymer composition or mixture subjected to the process is in molten form. In some embodiments, the melt processing can be performed by melting at least part of the polymer composition or mixture. In some embodiments, the melt processing step can be performed with externally applied heat. In other embodiments, the melt processing step itself can generate the heat necessary to melt (or partially melt) the mixture, polymer, or polymer composition. In an embodiment, the melt processing step can be an extrusion process, a melt kneading process, or a molding process. In some embodiments, the melt processing step of any method described herein can be an extrusion process; alternatively, a melt kneading process; or alternatively, a molding process. It should be noted, that when any process described herein employs more than one melt processing step, that each melt process step is independent of each other and thus each melt processing step can use the same or different melt processing method. Other melt processing methods are known to those having ordinary skill in the art can be utilized as the melt processing step.

The poly(arylene sulfide) can be formed or molded into a variety of components or products for a diverse range of applications and industries. For example, the poly(arylene sulfide) can be heated and molded into desired shapes and composites in a variety of processes, equipment, and operations. For example, the poly(arylene sulfide) can be subjected to heat, compounding, injection molding, blow molding, precision molding, film-blowing, extrusion, and so forth. Additionally, additives, such as those mentioned herein, can be blended or compounded within the poly(arylene sulfide) (e.g., PPS). The output of such techniques can include, for example, polymer intermediates or composites including the poly(arylene sulfide) (e.g., PPS), and manufactured product components or pieces formed from the poly(arylene sulfide) (e.g., PPS), and so on. These manufactured components can be sold or delivered directly to a user. On the other hand, the components can be further processed or assembled in end products, for example, in the industrial, consumer, automotive, aerospace, solar panel, and electrical/electronic industries, which can need polymers that have conductivity, high strength, and high modulus, among other properties. Some examples of end products include without limitation synthetic fibers, textiles, filter fabric for coal boilers, papermaking felts, electrical insulation, specialty membranes, gaskets, and packing materials.

In an embodiment, a process for producing a poly(arylene sulfide) polymer can comprise a step of contacting a by-product treatment additive with at least a portion of the first slurry. In such embodiment, the by-product treatment additive can be contacted with the first slurry as a solution, slurry, and/or dispersion in a polar organic compound and/or water. In some embodiments, the by-product treatment additive can be contacted with the first slurry as a solid (e.g., powder, crystals, hydrates, etc.).

In an embodiment, the first slurry can have a pH of from about 4 to about 11, alternatively from about 6 to about 10, or alternatively from about 7.5 to about 9.5, after contacting with the by-product treatment additive. For purposes of the disclosure herein, a first slurry comprising a by-product treatment additive can also be referred to as “treated first slurry.” As will be appreciated by one of skill in the art, and with the help of this disclosure, the by-product treatment additive can modify the pH of the first slurry regardless of whether it was contacted directly with the first slurry or whether it was contacted with the poly(arylene sulfide) reaction mixture and/or downstream product thereof prior to obtaining the first slurry. Further, as will be appreciated by one of skill in the art, and with the help of this disclosure, the by-product treatment additive is not expected to react with the poly(arylene sulfide) polymer prior to a step of evaporating a first slurry, and is expected to remain in liquid phase during washing/filtering steps, and as such is expected, for at least a portion of the by-product treatment additive, to be found (e.g., recovered) in the first slurry, even if the by-product treatment additive is being introduced in the process upstream of the first slurry.

In an embodiment, the first slurry (e.g., untreated first slurry) can have a pH of from about 9 to about 14, alternatively from about 9.5 to about 12, or alternatively from about 10 to about 11.5, prior to contacting with the by-product treatment additive. As will be appreciated by one of skill in the art, and with the help of this disclosure, the base (e.g., alkali metal hydroxides, such as sodium hydroxide, NaOH) utilized as a reagent during the polymerization reaction can be in excess, and such excess can increase the pH of the poly(arylene sulfide) reaction mixture and/or downstream product thereof (e.g., first slurry). In an embodiment, the base can be employed in the polymerization reaction in an amount of from about 0.98 mole to about 1.25 mole of base per mole of sulfur, alternatively from about 0.99 mole to about 1.15 mole of base per mole of sulfur, or alternatively from about 1 mole to about 1.1 mole of base per mole of sulfur.

In an embodiment, the by-product treatment additive is contacted with the poly(arylene sulfide) reaction mixture and/or downstream product thereof in an amount effective to yield a pH (e.g., a first slurry pH) of from about 4 to about 11, alternatively from about 6 to about 10, or alternatively from about 7.5 to about 9.5. As will be appreciated by one of skill in the art, and with the help of this disclosure, the amount of excess base used as a reagent can be calculated, and as such, the amount of by-product treatment additive that will reduce the pH of the first slurry to a desired value can be calculated and contacted with the poly(arylene sulfide) reaction mixture and/or downstream product thereof during any suitable process step between the end of the polymerization reaction and processing the first slurry, in order to reduce the pH of the first slurry to a desired value.

In an embodiment, a process for producing a poly(arylene sulfide) polymer can comprise the step of removing a portion of the first slurry (e.g., evaporating a portion of a liquid phase of a first slurry) to obtain a by-product slurry, wherein the by-product slurry comprises slurry particulates. In an embodiment, the poly(arylene sulfide) reaction mixture downstream product can comprise a by-product slurry. As will be appreciated by one of skill in the art, and with the help of this disclosure, at least a portion of the slurry particulates present in the by-product slurry have also been present in the first slurry. Further, as will be appreciated by one of skill in the art, and with the help of this disclosure, during the evaporation of a portion of the first slurry to obtain a by-product slurry, some of the particulates present in the first slurry can combine (e.g., aggregate, agglomerate, stick together, etc.) to produce the slurry particulates present in the by-product slurry. Without wishing to be limited by theory, during the evaporation of a portion of the first slurry to obtain a by-product slurry, some compounds that could be at least partially soluble in the first slurry, might not be as soluble in the by-product slurry and could precipitate out of the by-product slurry solution, due to either a reduction in liquid volume and/or a modification in the composition of a liquid phase of the by-product slurry when compared to a liquid phase of the first slurry. In an embodiment, the slurry particulates of the by-product slurry can comprise an alkali metal halide by-product (e.g., salt, NaCl), poly(arylene sulfide) polymer impurities (e.g., poly(arylene sulfide) fines, poly(arylene sulfide) oligomers, poly(arylene sulfide) low molecular weight polymers, polymerization reaction side-products, polymerization reaction by-products), a molecular weight modifying agent (e.g., an alkali metal carboxylate, sodium acetate), and the like, or combinations thereof. In an embodiment, the by-product slurry can comprise slurry particulates, dissolved salts (e.g., dissolved NaCl, dissolved alkali metal carboxylates, dissolved sodium acetate), a polar organic compound, water, and the like. As will be appreciated by one of skill in the art, and with the help of this disclosure, the amount and type of liquid present in the by-product slurry influences the solubility of components of the by-product slurry, and some slurry components (e.g., salts, NaCl, alkali metal carboxylates, sodium acetate) can be partially soluble in the by-product slurry, e.g., a portion of a slurry component can be present in the by-product slurry as a dissolved component (e.g., dissolved salt), while another portion of the same slurry component can be present in the by-product slurry as a solid particulate (e.g., slurry particulate).

In an embodiment, the step of evaporating a portion of the first slurry to obtain a by-product slurry can be accomplished by heating the first slurry, such as for example by external heating; by placing the first slurry in a jacketed vessel wherein hot water and/or steam can be run through a jacket of such vessel; by electrical heating; by internal heating; by contacting steam with a portion of the first slurry; and the like; or combinations thereof. In an embodiment, at least a portion of the first slurry can be transferred to a concentrator (e.g., a concentrator can receive at least a portion of the first slurry) for evaporating a portion of the first slurry to yield a by-product slurry. As will be appreciated by one of skill in the art, more than one concentrator can be used for evaporating a portion of the first slurry to yield the by-product slurry, such as for example two, three, four, five, six, or more concentrators can be used for evaporating a portion of the first slurry.

In an embodiment, the step of evaporating a portion of the first slurry to obtain a by-product slurry can yield one or more vapor streams. As will be appreciated by one of skill in the art, and with the help of this disclosure, a vapor stream can condense (i.e., change physical state from gas phase into liquid phase) to form a liquid fraction. In an embodiment, the one or more vapor streams can yield one or more first liquid fractions, wherein the one or more first liquid fractions can comprise water, a halogenated aromatic compound, a polar organic compound, or combinations thereof.

In an embodiment, the first liquid fractions can be further subjected to a step for the recovery of the halogenated aromatic compound and/or polar organic compound (e.g., a distillation step), to yield a recovered halogenated aromatic compound and/or a first recovered polar organic compound (e.g., recovered polar organic compound, recovered NMP, first recovered NMP). In an embodiment, at least a portion of the recovered halogenated aromatic compound and/or the first recovered polar organic compound can be recycled/reused in a subsequent polymerization process for the production of poly(arylene sulfide) (e.g., PPS). In an embodiment, the step of evaporating a portion of the first slurry to obtain a by-product slurry can comprise two or more sub-steps, such as for example a first sub-step wherein an aqueous liquid fraction is recovered, followed by a second sub-step, wherein an organic liquid fraction is recovered.

In an embodiment, at least a portion of the first recovered polar organic compound can be recycled/reused in a step of polymerizing reactants in a reaction vessel to produce a poly(arylene sulfide) reaction mixture and/or a step of processing the poly(arylene sulfide) reaction mixture to obtain a poly(arylene sulfide) polymer and a by-product slurry. In an embodiment, at least a portion of the first recovered polar organic compound can be recycled/reused in a step of washing the poly(arylene sulfide) reaction mixture with a polar organic compound and/or water to obtain a poly(arylene sulfide) polymer and a first slurry.

In an embodiment, the slurry particulates of the by-product slurry can be characterized by a slurry particulate size. As used herein, slurry particulate size (e.g., size of a slurry particulate of the by-product slurry) is determined in accordance with the ability of a slurry particulate to pass through a woven wire test sieve as described in ASTM E11-09. For purposes of this disclosure, all references to a woven wire test sieve refer to a woven wire test sieve as described in ASTM E11-09. As used herein, reference to slurry particulate size (e.g., size of a slurry particulate of the by-product slurry) refers to the size of an aperture (e.g., nominal aperture dimension) through which the slurry particulate (e.g., slurry particulate of the by-product slurry) will pass, and for brevity this is referred to herein as “slurry particulate size.” An aperture is an opening in a sieve (e.g., woven wire test sieve) or a screen for particles to pass through. The aperture of the woven wire test sieve is a square and the nominal aperture dimension refers to the width of the square aperture. For purposes of this disclosure, all references to the ability of a slurry particulate (e.g., slurry particulate of the by-product slurry) to pass through a woven wire test sieve refer to the ability of a slurry particulate to pass through a woven wire test sieve as measured in accordance with ASTM D1921-12. As will be appreciated by one of skill in the art, and with the help of this disclosure, the slurry particulate size is determined by wet testing, e.g., the ability of a slurry particulate to pass through a woven wire test sieve is measured by passing an amount of a slurry containing the slurry particulates through a woven wire test sieve. For example, a slurry particulate (e.g., slurry particulate of the by-product slurry) is considered to have a size of less than about 152 microns if the slurry particulate passes through the aperture of a 100 mesh woven wire test sieve, where the mesh size is given based on U.S. Sieve Series. As will be appreciated by one of skill in the art, and with the help of this disclosure, slurry particulates (e.g., slurry particulates of the by-product slurry) can have a plurality of shapes, such as for example cylindrical, discoidal, spherical, tabular, ellipsoidal, equant, irregular, or combinations thereof. Generally, for a slurry particulate to pass through an aperture of a sieve or screen, it is not necessary for all dimensions of the particle to be smaller than the aperture of such screen or sieve, and it could be enough for one of the dimensions of the slurry particulate to be smaller than the aperture of such screen or sieve. For example, if a cylindrically shaped slurry particulate that has a diameter of 100 microns and a length of 300 microns passes through the aperture of a 100 mesh woven wire test sieve, where the mesh size is according to U.S. Sieve Series, such slurry particulate is considered to have a slurry particulate size of less than about 152 microns. In an alternative embodiment, particle size analyzers, such as for example standard particle size analyzers, light scattering analyzers, etc., could also be used to determine slurry particulate size.

In an embodiment, the slurry particulates can be characterized by the slurry particulate size of from about 74 microns to about 177 microns, alternatively from about 88 microns to about 149 microns, or alternatively from about 105 microns to about 125 microns. In an embodiment, the slurry particulates can pass through a sieve or screen of from about 80 mesh (177 microns or 0.007 inches) to about 200 mesh (74 microns or 0.0029 inches), alternatively from about 100 mesh (149 microns or 0.0059 inches) to about 170 mesh (88 microns or 0.0035 inches), or alternatively from about 120 mesh (125 microns or 0.0049 inches) to about 140 mesh (105 microns or 0.0041 inches).

In an embodiment, a process for producing a poly(arylene sulfide) polymer can comprise a step of contacting a by-product treatment additive with at least a portion of the by-product slurry. In such embodiment, the by-product treatment additive can be contacted with the by-product slurry as a solution, slurry and/or dispersion in a polar organic compound and/or water. In some embodiments, the by-product treatment additive can be contacted with the by-product slurry as a solid (e.g., powder, crystals, hydrates, etc.).

In an embodiment, a process for producing a poly(arylene sulfide) polymer can comprise a step of removing (e.g., evaporating) at least a portion of the by-product slurry to yield salt solids particulates. In an embodiment, the step of removing (e.g., evaporating) at least a portion of the by-product slurry to yield salt solids particulates comprises removing (e.g., evaporating) at least a portion of the polar organic compound and/or water from the by-product slurry to yield salt solids particulates.

In an embodiment, the step of evaporating at least a portion of the by-product slurry to yield salt solids particulates comprises introducing at least a portion of the by-product slurry to a dryer, wherein at least a portion of liquid (e.g., a polar organic compound and/or water) in the by-product slurry can be evaporated. In an embodiment, the by-product slurry can be introduced (e.g., fed) to a dryer, to yield salt solids particulates and a second recovered polar organic compound.

In an embodiment, the dryer comprises a motor and one or more internal elements, wherein the motor can impart a rotational motion to the one or more internal elements. In such embodiment, the internal elements of the dryer can create a mixing action, wherein a material (e.g., by-product slurry, slurry particulates, salt solids particulates, etc.) inside the dryer can be in a three-dimensional motion throughout all or a portion of a body of the dryer. In such embodiment, the internal elements of the dryer can create a moving or displacing action, wherein a material (e.g., by-product slurry, slurry particulates, salt solids particulates, etc.) inside the dryer can be moved or displaced along all or a portion of a body of the sizing dryer between a by-product slurry port and a salt solids particulates outlet.

In an embodiment, the dryer comprises a receiving end, a delivering end, and a body, wherein the body is disposed between the receiving end and the delivering end. In an embodiment, the receiving end can comprise a by-product slurry port, wherein the by-product slurry can be introduced to the dryer through a by-product slurry port. In an embodiment, the by-product slurry port can be located (e.g., positioned, situated, placed, etc.) on a side of the dryer (e.g., on a receiving end of the dryer).

In an embodiment, the delivering end of the dryer comprises a salt solids particulates outlet. In some embodiments, the salt solids particulates outlet can be located on a side of the dryer (e.g., on a delivering end of the dryer), wherein the salt solids particulates outlet is adjacent to a bottom side of the dryer, e.g., the salt solids particulates outlet is located within a lower half of the dryer, e.g., within a lower half of the delivering end. In an embodiment, the salt solids particulates can be recovered (e.g., exit the dryer) through the salt solids particulates outlet. In an embodiment, materials (e.g., by-product slurry, slurry particulates, salt solids particulates, etc.) inside the dryer can move from the receiving end towards the delivering end, wherein the salt solids particulates can be recovered through the salt solids particulates outlet. In an embodiment, the salt solids particulates outlet can have a circular cross section, wherein the circular cross section of the salt solids particulates outlet can be characterized by a diameter of the circular cross section of the salt solids particulates outlet. In an embodiment, the diameter of the circular cross section of the salt solids particulates outlet can have a value of from about 100 cm to about 1 cm, alternatively from about 50 cm to about 2.5 cm, or alternatively from about 40 cm to about 10 cm. As will be appreciated by one of skill in the art and with the help of this disclosure, the size of the salt solids particulates outlet can be any suitable size that would allow the salt solids particulates to flow outside the dryer. For example, the salt solids particulates outlet could be as big as the body of the dryer. Further, for example, the salt solids particulates outlet could be as small as would allow the salt solids particulates to flow outside the dryer. As will be appreciated by one of skill in the art and with the help of this disclosure, the size of the salt solids particulates outlet can be just large enough to allow the salt solids particulates to flow out. For example, the size of the salt solids particulates outlet could be roughly greater than about 3 times the salt solids particulate size.

In an embodiment, the dryer can comprise one or more internal elements which can rotate within the dryer. In an embodiment, each of the internal elements can be characterized with respect to its own central or longitudinal internal element axis. In an embodiment, the dryer can be characterized with respect to a central or longitudinal dryer axis, wherein the dryer generally comprises a cylindrical or tubular structure or body (e.g., an elongated mixing chamber). In such embodiment, the longitudinal internal element axis can be parallel with the longitudinal dryer axis. In some embodiments, the internal elements can span/extend across substantially an entire length of the dryer. In other embodiments, the internal elements can extend across a partial length of the dryer. In an embodiment, the internal elements can assist in moving the material (e.g., by-product slurry, slurry particulates, salt solids particulates, etc.) across substantially an entire length of the dryer, e.g., from one end (e.g., a receiving end) towards another end (e.g., a delivering end) of the dryer. In some embodiments, the internal elements can have three dimensional features to aid the mixing and/or movement of the material (e.g., by-product slurry, slurry particulates, salt solids particulates, etc.) inside the dryer, wherein such features can comprise paddles, blades, augers, screws, helices, and the like, or combinations thereof. In an embodiment, the dryer can comprise two internal elements with paddles, wherein the internal elements can have the same or opposite rotating motion. For example, the internal elements can have opposite rotating motion, e.g., one internal element can rotate clockwise while the other internal element can rotate counter-clockwise.

In an embodiment, the internal elements can be connected to a powering device (e.g., a motor, a dryer motor), wherein the powering device can impart motion to the internal elements, thereby causing the mixing and/or movement of material (e.g., by-product slurry, slurry particulates, salt solids particulates, etc.) inside the dryer (e.g., inside the body of the dryer). In an embodiment, the motion (e.g., rotation) of the internal elements can be modulated (e.g., modified, controlled, varied, adjusted), e.g., the intensity of the motion (e.g., rotation) of the internal elements can be adjusted.

In an embodiment, the dryer motor can be characterized by a torque. Generally, torque can be thought of as a measure of how much a force acting on an object can cause that object to rotate (e.g., a tendency of a force to rotate an object about an object's axis). Mathematically, the torque can be defined as the rate of change of an angular momentum of an object and can be expressed in Newton meter (N·m). The torque can generally be measured with torque rheometers and/or torque sensors. Torque rheometers can generally employ a dynamometer which can consist of a movable gear box coupled to a load cell by means of a torque arm. When the rotating object is subjected to a torque load, the dynamometer activates the load cell which in turn provides a signal for torque recording.

As will be appreciated by one of skill in the art, and with the help of this disclosure, the torque of the dryer motor can increase as a rotational motion of the internal elements of the dryer decreases (e.g., the dryer motor slows down) due to an increase in the size of the salt solids particulates. Further, as will be appreciated by one of skill in the art, and with the help of this disclosure, a decrease in the size of the salt solids particulates can lead to a decrease in the torque, e.g., can lead to a lower load on the dryer motor.

In an embodiment, a torque of the dryer motor is reduced by from about 20% to about 100%, alternatively from about 25% to about 95%, or alternatively from about 30% to about 90%, when compared to a torque of the dryer motor used for evaporating an otherwise similar by-product slurry in the absence of treatment with the by-product treatment additive. As will be appreciated by one of skill in the art, and with the help of this disclosure, the by-product treatment additive present in the by-product slurry can originate in a by-product treatment additive that was either contacted with the by-product slurry or that was contacted upstream of the by-product slurry with the poly(arylene sulfide) reaction mixture and/or downstream product thereof (e.g., reaction mixture, first slurry, etc.).

In an embodiment, the by-product treatment additive can be contacted with the poly(arylene sulfide) reaction mixture and/or downstream product thereof in an amount effective to reduce a torque of the dryer motor used for evaporating at least a portion of a by-product slurry by from about 20% to about 100%, alternatively from about 25% to about 95%, or alternatively from about 30% to about 90%, when compared to a torque of the dryer motor used for evaporating an otherwise similar by-product slurry in the absence of treatment with the by-product treatment additive.

In an embodiment, the dryer can be heated to promote evaporation and recovery of a polar organic compound, e.g., a recovered polar organic compound (e.g., recovered NMP), and a second recovered polar organic compound (e.g., a second recovered NMP). In an embodiment, at least a portion of the second recovered polar organic compound can be recycled/reused in a subsequent polymerization process for the production of poly(arylene sulfide) (e.g., PPS).

In an embodiment, at least a portion of the second recovered polar organic compound can be recycled/reused in a step of polymerizing reactants in a reaction vessel to produce a poly(arylene sulfide) reaction mixture and/or a step of processing the poly(arylene sulfide) reaction mixture to obtain a poly(arylene sulfide) polymer and a by-product slurry. In an embodiment, at least a portion of the second recovered polar organic compound can be recycled/reused in a step of washing the poly(arylene sulfide) reaction mixture with a polar organic compound and/or water to obtain a poly(arylene sulfide) polymer and a first slurry.

In an embodiment, the dryer can be heated by external heating, jacket heating, internal heating, introducing steam to the dryer, heating internal elements of the dryer, and the like, or combinations thereof.

In an embodiment, internal heating comprises further introducing steam to the dryer. In such embodiment, the steam can be introduced to the dryer through a steam port. In an embodiment, the steam port can be located on a side of the dryer. In an embodiment, the receiving end of the dryer comprises the steam port.

In an embodiment, the steam port and the by-product slurry port can be positioned adjacent to each other, e.g., in close spatial proximity to each other. In some embodiments, the steam port and the by-product slurry port can be positioned in a concentric position with respect to each other. As will be appreciated by one of skill in the art, and with the help of this disclosure, one of the ports can be positioned in the middle of another annular port, wherein the cross section of the ports can have any suitable geometry, circular, elliptical, square, rectangular, etc. In an embodiment, the by-product slurry port is a circular port surrounded by an annular circular steam port. In an alternative embodiment, the steam port is a circular port surrounded by an annular circular by-product slurry port. In an embodiment, the steam port can comprise any suitable configuration that allows for an effective heat transfer between the steam and the by-product slurry, thereby enabling the recovery of at least a portion of the polar organic compound of the by-product slurry (e.g., recovered second polar organic compound).

In an embodiment, at least a portion of the polar organic compound of the by-product slurry can be recovered as recovered polar organic compound through a polar organic compound outlet. In some embodiments, the polar organic compound outlet can be located on a top side of the dryer. In other embodiments, the polar organic compound outlet can be located on a side of the dryer, wherein the polar organic compound outlet is adjacent to a top side of the dryer, e.g., the polar organic compound outlet is located within an upper half of the dryer. As will be appreciated by one of skill in the art, and with the help of this disclosure, the polar organic compound is recovered through the polar organic compound outlet as polar organic compound vapors. Further, as will be appreciated by one of skill in the art, and with the help of this disclosure, when steam is introduced to the dryer along with the by-product slurry, water vapors of the steam can also be recovered along with the polar organic compound through a polar organic compound outlet. In an embodiment, the second recovered polar organic compound can comprise water in an amount of less than about 80 wt. %, alternatively less than about 50 wt. %, or alternatively less than about 30 wt. %, based on the total weight of the second recovered polar organic compound. In an embodiment, the polar organic compound vapors can further condense to yield a polar organic compound liquid fraction (e.g., a second recovered polar organic compound).

In an embodiment, the second recovered polar organic compound can be further processed (e.g., dehydrated, purified, etc.) and/or recycled/reused in a subsequent polymerization process for the production of poly(arylene sulfide) (e.g., PPS). In an embodiment, the second recovered polar organic compound can be further subjected to a dehydration process (e.g., water removal process) and/or to a purification process (e.g., distillation) prior to being recycled/reused in a subsequent polymerization process for the production of poly(arylene sulfide) (e.g., PPS).

In some embodiments, the dryer can be operated in a continuous flow mode (as opposed to a batch mode), wherein the by-product slurry is continuously introduced to the dryer, while a second recovered polar organic compound and salt solids particulates are continuously recovered. In other embodiments, the dryer can be operated in a batch mode (as opposed to a continuous flow mode), wherein a predetermined quantity of the by-product slurry is introduced to the dryer, followed by recovery of at least a portion of the polar organic compound and the salt solids particulates. In some other embodiments, the dryer can be operated in a semi-batch mode, wherein a predetermined quantity of the by-product slurry is introduced to the dryer, and at least a part of the recovery of at least a portion of the polar organic compound and the salt solids particulates occurs at the same time as the introduction of the by-product slurry to the dryer. In yet other embodiments, the dryer can be operated in a pulse continuous fashion, wherein contents of the dryer can be partially dumped (e.g., removed from the dryer) followed by introducing more by-product slurry to the dryer, in a pulse manner, and wherein a time between pulses allows for removal of enough polar organic compound to achieve a desirable dryness level of the salt solids particulates.

In an embodiment, the salt solids particulates can be recovered from the dryer through the salt solids particulates outlet. In an embodiment, the salt solids particulates can originate (e.g., come, arise, etc.) from the by-product slurry, and can comprise slurry particulates, combined (e.g., aggregated, agglomerated, stuck together, joined together, etc.) slurry particulates, and particulates that precipitate out of the solution as the amount of the liquid phase of the slurry diminishes due to the evaporation and/or recovery of polar organic compound, wherein the particulates that precipitate out of the solution can originate in the dissolved salts of the by-product slurry (e.g., dissolved NaCl, dissolved alkali metal carboxylates, dissolved sodium acetate).

As will be appreciated by one of skill in the art, and with the help of this disclosure, some slurry particulates will aggregate, thereby forming some of the salt solids particulates that have a size larger than any of the slurry particulates that have entered the dryer as part of the by-product slurry. For purposes of the disclosure herein, particulate agglomerations are basically salt solids particulates that have grown (e.g., aggregated) to a size larger than a desired size for the salt solids particulates, e.g., a size of the salt solids particulates that allows the salt solids particulates to exit the dryer through a salt solids particulates outlet. For purposes of the disclosure herein, “agglomerating” refers to the process through which the particulates in a slurry (e.g., a by-product slurry) grow to undesirably large sizes, such as for example to yield particulate agglomerations.

In an embodiment, evaporating at least a portion of the polar organic compound from the by-product slurry can cause the slurry particulates and/or salt solids particulates (e.g., forming and/or already formed salt solids particulates) to combine (e.g., become more intimately contacted and bound in some fashion), thereby forming larger salt solids particulates (e.g., particulates, particulate agglomerations, etc.). Without wishing to be limited by theory, particulate agglomerations can occur/form when a salt (e.g., alkali metal halide by-product, NaCl, alkali metal carboxylates, sodium acetate) crystallizes due to evaporation/removal of at least a portion of a liquid phase of the by-product slurry, wherein the poly(arylene sulfide) polymer impurities (e.g., poly(arylene sulfide) fines, poly(arylene sulfide) oligomers, poly(arylene sulfide) low molecular weight polymers, and polymerization reaction side-products, polymerization reaction by-products) stick or adhere to salt crystals, thereby binding or gluing the salt crystals together, to yield particulate agglomerations.

In an embodiment, the salt solids particulates can comprise an alkali metal halide by-product (e.g., salt, NaCl) and/or poly(arylene sulfide) polymer impurities (e.g., poly(arylene sulfide) fines, poly(arylene sulfide) oligomers, poly(arylene sulfide) low molecular weight polymers, polymerization reaction side-products, polymerization reaction by-products). In an embodiment, the salt solids particulates can further comprise a molecular weight modifying agent (e.g., an alkali metal carboxylate, sodium acetate). As will be appreciated by one of skill in the art, and with the help of this disclosure, other impurities, such as for example traces of reagents, by-products of the polymerization reaction, and the like, can also be present in the salt solids particulates. Without wishing to be limited by theory, during the step of evaporating the by-product slurry to yield salt solids particulates at least a portion of the poly(arylene sulfide) polymer impurities can be degraded, wherein the molecular weight of the poly(arylene sulfide) polymer impurities can be lowered or decreased. Further, without wishing to be limited by theory, the degradation of the poly(arylene sulfide) polymer impurities can be caused by the elevated temperature in the dryer during the evaporation step. Further, without wishing to be limited by theory, the degradation of the poly(arylene sulfide) polymer impurities can be the result of poly(arylene sulfide) polymer impurities chains being cleaved, thereby resulting in poly(arylene sulfide) polymer impurities chains of lower molecular weight. As will be appreciated by one of skill in the art, and with the help of this disclosure, the poly(arylene sulfide) polymer impurities can degrade prior to the step of evaporating the by-product slurry to yield salt solids particulates, if such polymer impurities are exposed to any degrading agents and/or conditions (e.g., heat). For example, the degradation of the poly(arylene sulfide) polymer impurities can occur during the step of evaporating the first slurry, and as such it could be beneficial to add an amount of by-product treatment additive to the poly(arylene sulfide) reaction mixture and/or downstream product thereof prior to the step of evaporating the first slurry. Without wishing to be limited by theory, degraded poly(arylene sulfide) polymer impurities (e.g., poly(arylene sulfide) polymer impurities of lower molecular weight) can lead to larger size salt solids particulates by enabling agglomeration of salt solids particulates.

In an embodiment, contacting the by-product treatment additive with the poly(arylene sulfide) reaction mixture and/or downstream product thereof can reduce agglomeration of salt solids particulates. Without wishing to be limited by theory, the by-product treatment additive could alter the interactions between a liquid phase (e.g., solvent) of the by-product slurry and the poly(arylene sulfide) polymer impurities, as well as the alkali metal halide by-product, which in turn could lead to a less “pasty” material in the dryer, thereby reducing the agglomeration of salt solids particulates. Further, without wishing to be limited by theory, the by-product treatment additive could terminate the reaction that results in cleaving the poly(arylene sulfide) polymer impurities chains.

In an embodiment, the by-product treatment additive can decrease the degradation of the poly(arylene sulfide) polymer impurities (e.g., poly(arylene sulfide) fines, poly(arylene sulfide) oligomers, poly(arylene sulfide) low molecular weight polymers, polymerization reaction side-products, polymerization reaction by-products).

In an embodiment, a weight average molecular weight of the poly(arylene sulfide) polymer impurities can be by from about 1.01 times greater to about 40 times greater, alternatively from about 1.1 times greater to about 37.5 times greater, alternatively from about 1.5 times greater to about 35 times greater, alternatively from about 2 times greater to about 32.5 times greater, alternatively from about 2.5 times greater to about 30 times greater, alternatively from about 5 times greater to about 27.5 times greater, alternatively from about 10 times greater to about 25 times greater, alternatively from about 15 times greater to about 22.5 times greater, or alternatively from about 17.5 times greater to about 20 times greater, than a weight average molecular weight of poly(arylene sulfide) polymer impurities of an otherwise similar by-product slurry in the absence of treatment with a by-product treatment additive. The weight average molecular weight describes the size average of a polymer composition and can be calculated according to equation 1:

$${M}_{w} = \frac{{\sum }_{i} {N}_{i} {M}_{i}^{2}}{{\sum }_{i} {N}_{i} {M}_{i}} \qquad ( 1 )$$

wherein N₁ is the number of molecules of molecular weight Mᵢ. All molecular weight averages are expressed in gram per mole (g/mol) or Daltons (Da). As will be appreciated by one of skill in the art, and with the help of this disclosure, the greater molecular weight of the poly(arylene sulfide) polymer impurities is due to less degradation of the polymer impurities.

In an embodiment, the salt solids particulates can comprise an alkali metal halide by-product (e.g., salt, NaCl) in an amount of from about 50 wt. % to about 99 wt. %, alternatively, from about 75 wt. % to about 95 wt. %, or alternatively, from about 80 wt. % to about 90 wt. %, based on the total weight of the salt solids particulates. In an embodiment, the alkali metal halide by-product (e.g., salt, NaCl) can comprise the balance of the salt solids particulates after considering the amount of the other components. In an embodiment, the alkali metal halide by-product comprises NaCl.

In an embodiment, the salt solids particulates can comprise polymer impurities (e.g., poly(arylene sulfide) fines, poly(arylene sulfide) oligomers, poly(arylene sulfide) low molecular weight polymers, polymerization reaction side-products, polymerization reaction by-products) in an amount of from about 1 wt. % to about 50 wt. %, alternatively, from about 5 wt. % to about 25 wt. %, or alternatively, from about 10 wt. % to about 20 wt. %, based on the total weight of the salt solids particulates.

In an embodiment, the salt solids particulates can further comprise a polar organic compound, e.g., a polar organic compound that was not removed in the dryer. In an embodiment, the salt solids particulates can comprise a polar organic compound in an amount of from equal to or less than about 5 wt. %, alternatively less than about 1 wt. %, alternatively less than about 0.5 wt. %, alternatively less than about 0.1 wt. %, alternatively less than about 0.01 wt. %, alternatively less than about 0.001 wt. %, alternatively less than about 0.0001 wt. %, or alternatively about 0 wt. %, based on the total weight of the salt solids particulates.

In an embodiment, the salt solids particulates can be characterized by a salt solids particulate size (e.g., a desired size for the salt solids particulates). As used herein, reference to salt solids particulate size (e.g., size of a salt solids particulate obtained by evaporating at least a portion of the polar organic compound from the by-product slurry) refers to the size of an aperture (e.g., salt solids particulates outlet) through which the salt solids particulate (e.g., a salt solids particulate obtained by evaporating at least a portion of the polar organic compound from the by-product slurry) will pass, and for brevity this is referred to herein as “salt solids particulate size.” As will be appreciated by one of skill in the art, and with the help of this disclosure, salt solids particulates can have a plurality of shapes, such as for example cylindrical, discoidal, spherical, tabular, ellipsoidal, equant, irregular, or combinations thereof. Generally, for a salt solids particulate to pass through an aperture (e.g., salt solids particulates outlet), it is not necessary for all dimensions of the particulate to be smaller than the aperture, and it could be enough for one of the dimensions of the salt solids particulate to be smaller than the aperture. In an embodiment, the salt solids particulate size can be determined by measurements similar to standard particulate (e.g., particle) size measurements, such as physically sifting the material (e.g., sifting through a woven wire test sieve) through a sieve or test sieve; and/or by standard particulate (e.g., particle) size measurements, such as physically sifting (e.g., wet sifting) the material (e.g., sifting through a woven wire test sieve) in accordance with ASTM D1921-12. As will be appreciated by one of skill in the art, and with the help of this disclosure, the size of the salt solids particulate can be fairly large, wherein the salt solids particulates can be too large to pass through any sizes of test sieves available as part of the U.S. Sieve Series. Further, as will be appreciated by one of skill in the art, and with the help of this disclosure, test sieves can be designed for testing such materials, wherein the test sieves are assembled according to the standards of the U.S. Sieve Series, however, with apertures large enough to allow the material to be tested to pass through such apertures. For purposes of the disclosure herein, the aperture of a test sieve is a square and the aperture dimension refers to the width of the square aperture, whether the sieve is a woven wire test sieve or a test sieve that was assembled specifically for measuring the size of the salt solids particulates. For example, if a salt solids particulate comprises a cylinder with a height of 55 mm and a diameter of 23 mm, and the test sieve aperture has a size of 25 mm, then the salt solids particulate can pass through the aperture of the test sieve and it is considered that the salt solids particulate size is less than about 25 mm.

In an embodiment, the salt slurry particulates can be characterized by a size (e.g., a desired size) of less than about 150 mm, alternatively less than about 100 mm, alternatively less than about 50 mm, alternatively less than about 25 mm, alternatively less than about 10 mm, alternatively less than about 9 mm, alternatively less than about 8 mm, alternatively less than about 7 mm, alternatively less than about 6 mm, alternatively less than about 5 mm, alternatively less than about 4 mm, alternatively less than about 3 mm, alternatively less than about 2 mm, alternatively less than about 1 mm, alternatively less than about 0.5 mm, alternatively less than about 0.1 mm, alternatively less than about 0.05 mm, or alternatively less than about 0.03 mm.

In an embodiment, a ratio of a size of the salt solids particulates to the diameter of the salt solids particulates outlet (e.g., the diameter of the circular cross section of the salt solids particulates outlet) can be less than about 0.9, alternatively, less than about 0.75, alternatively, less than about 0.5, alternatively, less than about 0.25, or alternatively, less than about 0.1.

In an embodiment, a ratio of a size of the salt solids particulates to a size of the slurry particulates can be less than about 10, alternatively, less than about 5, alternatively, less than about 3, alternatively, less than about 1, or alternatively, less than about 0.5.

In an embodiment, a size of the salt solids particulates can be reduced by from about 5% to about 95%, alternatively from about 10% to about 90%, or alternatively from about 15% to about 85%, when compared to a size of the salt solids particulates obtained by evaporating an otherwise similar by-product slurry in the absence of treatment with the by-product treatment additive.

In an embodiment, the by-product treatment additive can be contacted with the poly(arylene sulfide) reaction mixture and/or downstream product thereof in an amount effective to reduce a size of the salt solids particulates obtained by evaporating at least a portion of a by-product slurry by from about 5% to about 95%, alternatively from about 10% to about 90%, or alternatively from about 15% to about 85%, when compared to a size of the salt solids particulates obtained by evaporating an otherwise similar by-product slurry in the absence of treatment with the by-product treatment additive.

In an embodiment, the salt solids particulates recovered from the dryer can be further solubilized in water and/or an aqueous solution, to yield a salt solution. In such embodiment, the alkali metal halide by-product (e.g., salt, NaCl), as well as any other salts that could be present in the salt solids particulates (e.g., a molecular weight modifying agent, an alkali metal carboxylate, sodium acetate) can be solubilized in the water and/or an aqueous solution, to yield the salt solution, while the poly(arylene sulfide) polymer impurities (e.g., poly(arylene sulfide) fines, poly(arylene sulfide) oligomers, poly(arylene sulfide) low molecular weight polymers, polymerization reaction side-products, polymerization reaction by-products) would remain as a solid phase in the salt solution. In an embodiment, the salt solution can be further filtered to remove the poly(arylene sulfide) polymer impurities. In an embodiment, the poly(arylene sulfide) polymer impurities can be discarded or disposed of. In an embodiment, the salt solution can be discarded or disposed of. In an alternative embodiment, the salt solution can be recycled.

In an embodiment, a process for producing a poly(phenylene sulfide) polymer can comprise the steps of (a) polymerizing reactants in a reaction vessel to produce a poly(phenylene sulfide) reaction mixture; (b) processing at least a portion of the poly(phenylene sulfide) reaction mixture to obtain a poly(phenylene sulfide) reaction mixture downstream product; (c) contacting a by-product treatment additive with at least a portion of the poly(phenylene sulfide) reaction mixture and/or downstream product thereof; and (d) processing at least a portion of the poly(phenylene sulfide) reaction mixture downstream product to yield salt solids particulates, wherein the by-product treatment additive can reduce agglomeration of the salt solids particulates. In an embodiment, step (b) processing the poly(phenylene sulfide) reaction mixture can comprise washing the at least a portion of the poly(phenylene sulfide) reaction mixture with N-methyl-2-pyrrolidone and/or water to obtain a washed poly(phenylene sulfide) polymer and a first slurry, wherein the by-product treatment additive can be contacted with at least a portion of the first slurry, and wherein the first slurry can have a pH of from about 4 to about 11 after contacting with the by-product treatment additive. In such embodiment, the by-product treatment additive can comprise acetic acid.

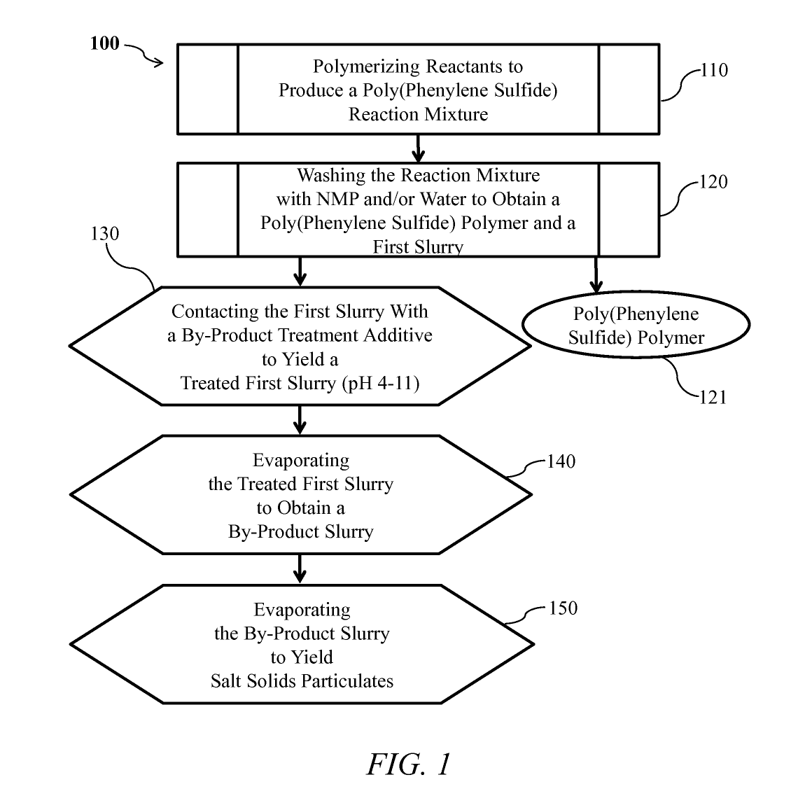

Referring to the embodiment of FIG. 1, a process 100 for producing a poly(phenylene sulfide) polymer is illustrated. The process 100 for producing a poly(phenylene sulfide) polymer can generally comprise (a) a step 110 of polymerizing reactants in a reaction vessel to produce a poly(phenylene sulfide) reaction mixture; (b) a step 120 of washing at least a portion of the poly(phenylene sulfide) reaction mixture with N-methyl-2-pyrrolidone and/or water to obtain a poly(phenylene sulfide) polymer 121 and a first slurry; (c) a step 130 of contacting at least a portion of the first slurry with a by-product treatment additive to yield a treated first slurry having a pH of from about 4 to about 11; (d) a step 140 of evaporating at least portion of the treated first slurry to obtain a by-product slurry comprising poly(phenylene sulfide) polymer impurities, wherein a weight average molecular weight of the poly(phenylene sulfide) polymer impurities can be by from about 1.01 times greater to about 40 times greater than a weight average molecular weight of poly(phenylene sulfide) polymer impurities of an otherwise similar by-product slurry in the absence of treatment with the by-product treatment additive; and (e) a step 150 of evaporating at least portion of the by-product slurry to yield salt solids particulates, wherein the by-product treatment additive can reduce agglomeration of the salt solids particulates. In such embodiment, the by-product treatment additive comprises sodium carbonate and/or sodium bicarbonate.

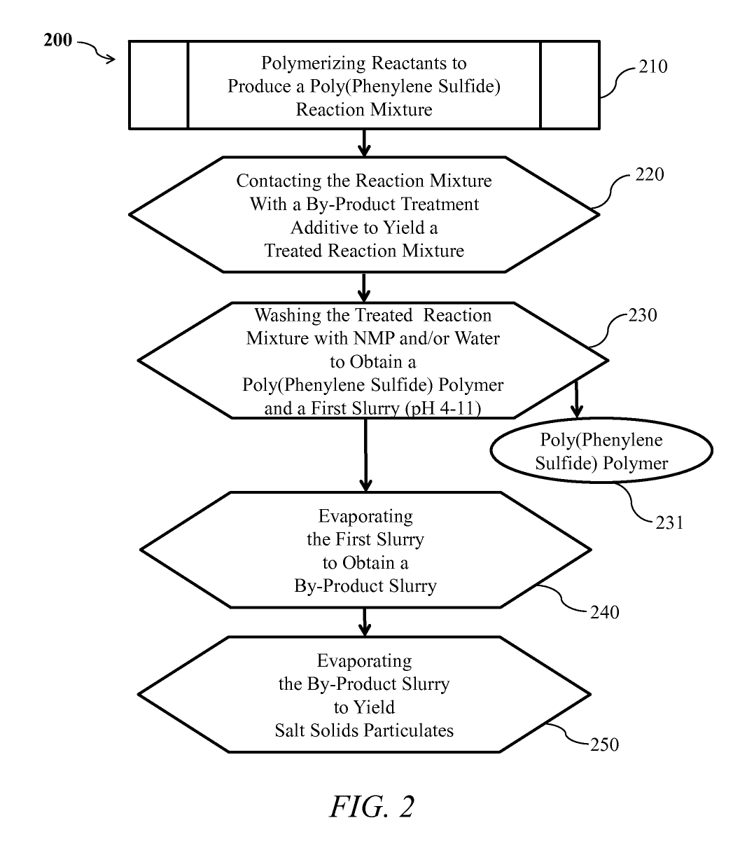

Referring to the embodiment of FIG. 2, a process 200 for producing a poly(phenylene sulfide) polymer is illustrated. The process 200 for producing a poly(phenylene sulfide) polymer can generally comprise (a) a step 210 of polymerizing reactants in a reaction vessel to produce a poly(phenylene sulfide) reaction mixture; (b) a step 220 of contacting at least a portion of the poly(phenylene sulfide) reaction mixture with a by-product treatment additive to yield a treated poly(phenylene sulfide) reaction mixture; (c) a step 230 of washing at least a portion of the treated poly(phenylene sulfide) reaction mixture with N-methyl-2-pyrrolidone and/or water to obtain a poly(phenylene sulfide) polymer 231 and a first slurry having a pH of from about 4 to about 11; (d) a step 240 of evaporating at least portion of the first slurry to obtain a by-product slurry comprising poly(phenylene sulfide) polymer impurities, wherein a weight average molecular weight of the poly(phenylene sulfide) polymer impurities can be by from about 1.01 times greater to about 40 times greater than a weight average molecular weight of poly(phenylene sulfide) polymer impurities of an otherwise similar by-product slurry in the absence of treatment with the by-product treatment additive; and (e) a step 250 of evaporating at least portion of the by-product slurry to yield salt solids particulates, wherein the by-product treatment additive can reduce agglomeration of the salt solids particulates. In such embodiment, the by-product treatment additive can comprise propionic acid.

In an embodiment, a system for producing a poly(phenylene sulfide) polymer can comprise (a) a reactor, wherein a sulfur source and p-dichlorobenzene are reacted in the presence of N-methyl-2-pyrrolidone to form a poly(phenylene sulfide) reaction mixture; and (b) a solvent recovery system receiving at least a portion of the poly(phenylene sulfide) reaction mixture, wherein the solvent recovery system can comprise: (i) a washing vessel receiving at least a portion of the poly(phenylene sulfide) reaction mixture, wherein at least a portion of the poly(phenylene sulfide) reaction mixture can be washed with N-methyl-2-pyrrolidone and/or water to obtain a washed poly(phenylene sulfide) polymer and a first slurry; (ii) a tank receiving at least a portion of the first slurry, wherein the first slurry can have pH of from about 4 to about 11; (iii) a concentrator receiving at least portion of the first slurry having a pH of from about 4 to about 11, wherein at least a portion of the first slurry having a pH of from about 4 to about 11 can be evaporated to yield a by-product slurry; and (iv) a dryer receiving at least portion of the by-product slurry, wherein at least portion of the by-product slurry can be evaporated to yield salt solids particulates; wherein a by-product treatment additive can be added to the solvent recovery system in the b(i) washing vessel, the b(ii) tank and/or the b(iii) concentrator; and wherein the by-product treatment additive can reduce agglomeration of the salt solids particulates in the b(iv) dryer. In such embodiment, the by-product treatment additive comprises dry ice.

In an embodiment, the process for producing a poly(arylene sulfide) polymer as disclosed herein advantageously displays improvements in one or more process characteristics when compared to an otherwise similar process in the absence of a step of contacting a by-product treatment additive with at least a portion of the poly(arylene sulfide) reaction mixture and/or downstream product thereof. For example, a conventional process for producing poly(arylene sulfide) polymer could sometimes allow for the formation of large rock-solid clumps (e.g., agglomerations of salt solids particles, agglomerations of slurry particles, etc.) that could cause the equipment to be shut down, and thus could cause the entire process for the production of a polymer (e.g., a poly(arylene sulfide) polymer) to be shut down, thereby causing monetary damages due to down time. The use of the by-product treatment additive as disclosed herein can advantageously reduce and/or eliminate down time by reducing the agglomeration of salt solids particulates into large rock-solid clumps (e.g., agglomerations of salt solids particles, agglomerations of slurry particles, etc.) in the dryer.

In an embodiment, the use of the by-product treatment additive as disclosed herein can advantageously maintain flowability of materials (e.g., by-product slurry, slurry particulates, salt solids particulates, etc.) through the dryer. In such embodiment, the use of the by-product treatment additive as disclosed herein can advantageously display improved operation of equipment, improved reliability of equipment, reduced operational problems (e.g., equipment plugging), reduced down time resulting in a more continuous process operation, etc. Additional advantages of the process for the production of a poly(arylene sulfide) polymer as disclosed herein can be apparent to one of skill in the art viewing this disclosure.

### EXAMPLES

The subject matter having been generally described, the following examples are given as particular embodiments of the disclosure and to demonstrate the practice and advantages thereof. It is understood that the examples are given by way of illustration and are not intended to limit the specification of the claims to follow in any manner.

### Example 1

The effect of a by-product treatment additive on salt solids particulate drying was studied. More specifically, the effect of the type of by-product treatment additive on the torque of the dryer motor was investigated. Various PPS samples were prepared. General reaction conditions (e.g., reaction cycle, stoichiometry, etc.) were previously described herein.

For example, PPS can be prepared according to the following recipe describing an example of a reaction cycle. To a 1-liter titanium reactor was added 0.666 mole of NaSH (62.50 grams), 0.680 mole of NaOH (27.61 grams), and 1.665 moles of N-methyl-2-pyrrolidone (165.05 grams). The reactor was closed and the reactor stirrer operated at 175 revolutions per minute. The reactor was purged of air by charging the reactor with nitrogen to 50 psig and then depressurizing the reactor five consecutive times, and then charging the reactor with nitrogen to 200 psig and then depressurizing the reactor five consecutive times. Water was then removed (also referred to as dehydration) from the reactor by heating the reactor to approximately 140° C. The dehydration line was then opened, a nitrogen flow rate of 32 cc/minute was introduced into the reactor, and the reactor was heated to approximately 200° C. over a period of 95 minutes. During this time 25 mL of liquid was collected. Gas chromatography of the collected liquid indicated that the collected liquid contained 96 weight % water and 4.0 weight % N-methyl-2-pyrrolidone. Upon completion of the dehydration, the dehydration line was closed, the reactor was charged to 50 psig with nitrogen, and the nitrogen flow was discontinued. The reactor was then heated to 250° C. To a 0.3 liter charging vessel was added 0.666 mole of para-dichlorobenzene (98.0 grams) and 0.25 mole of N-methyl-2-pyrrolidone (25.0 grams). The charging vessel was then purged with nitrogen, closed, and placed in a heated bath (at approximately 100° C.) until it was to be charged to the reactor. When the reactor reached 250° C., the contents of the charging vessel were then pressured (nitrogen pressure) into the reactor. The charging vessel was rinsed with 0.5 mole of N-methyl-2-pyrrolidone (49.56 grams) and the rinse was pressured (nitrogen pressure) into the reactor. Once the contents of the charging vessel were charged to the reactor, the reactor temperature was increased to 250° C. and was maintained at 250° C. for approximately four hours. The reaction mixture was then quenched and further filtered to remove resin particles (e.g., poly(phenylene sulfide) particles) and a filtrate.

Different filtrate samples were treated with various amounts of water and/or by-product treatment additive, as indicated in Table 1. The amount of water added is given in weight % (wt. %). When the by-product treatment additive was an acid and/or an acid precursor (e.g., acetic acid, dry ice, CO₂), an amount of acid effective to achieve the pH value indicated in Table 1 was used.

TABLE 1

| | By-Product | | |
|---|---|---|---|
| | Treatment Additive | Water | pH Adjustment |
| Sample #1 | — | — | — |
| Sample #2 | — | 10% | — |
| Sample #3 | acetic acid | 10% | 8 |
| Sample #4 | acetic acid | 10% | 10 |

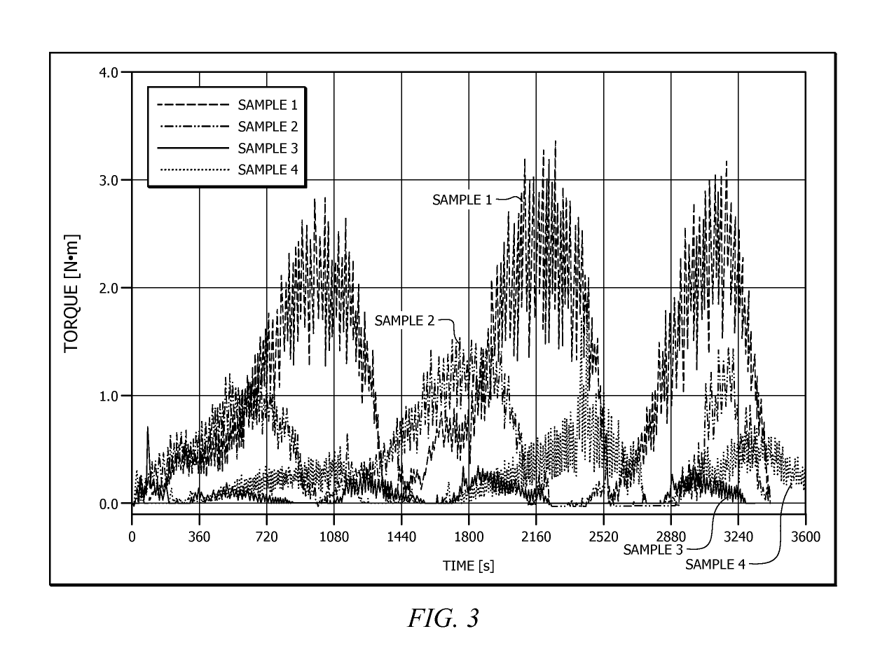

The samples from Table 1 were dried in a Brabender lab dryer which was equipped with a torque rheometer. The torque of the dryer motor was recorded and the data are displayed in FIG. 3. When water was added to the filtrate sample, the torque was decreased (e.g., Sample #2 vs. Sample #1 in FIG. 3). The addition of water could cause the flocculation of oligomers, rendering them in a solid state prior to the drying step, and as such could reduce the agglomeration of salt solids particulates during the drying step. However, while the addition of water to the filtrate samples decreased the torque, the addition of a by-product treatment additive (e.g., acetic acid) resulted in a more dramatic decrease in torque (e.g., Sample #4 vs. Sample #1 in FIG. 3). Further decreasing the pH of the sample achieved an even greater torque decrease (e.g., Sample #3 at pH 8 vs. Sample #4 at pH 10 in FIG. 3).

### Example 2

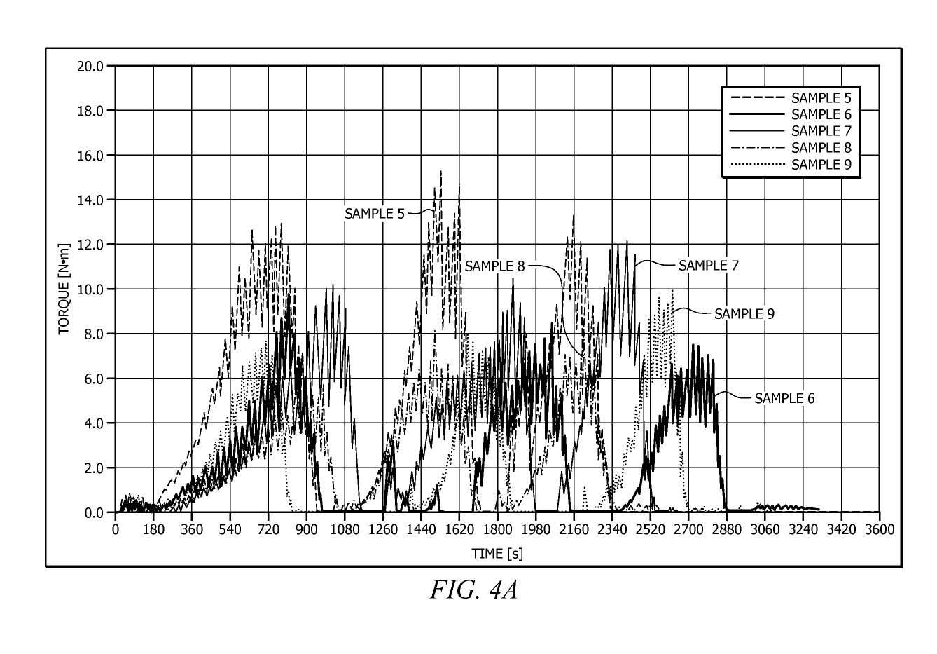

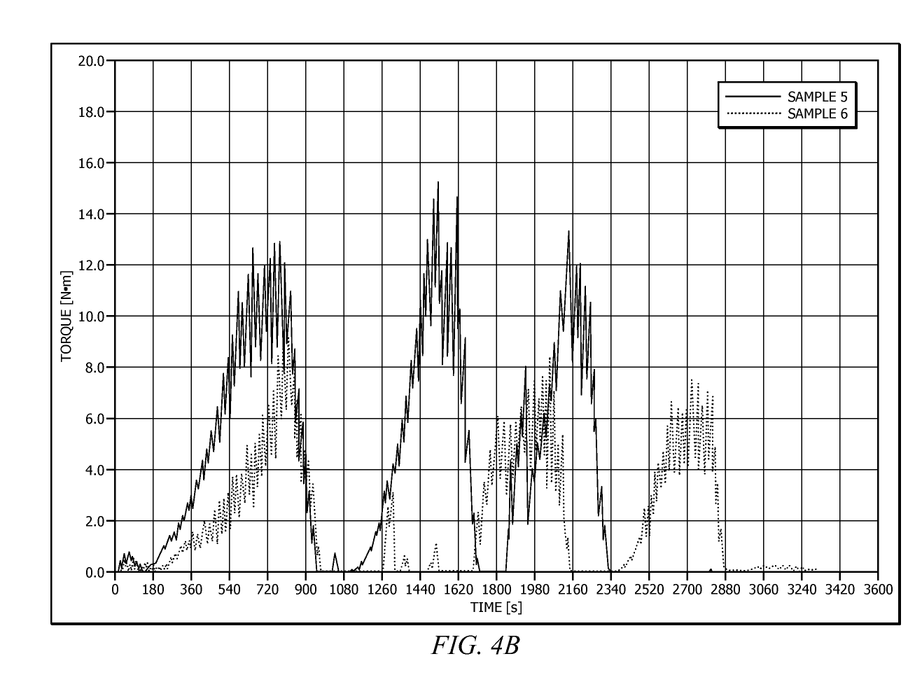

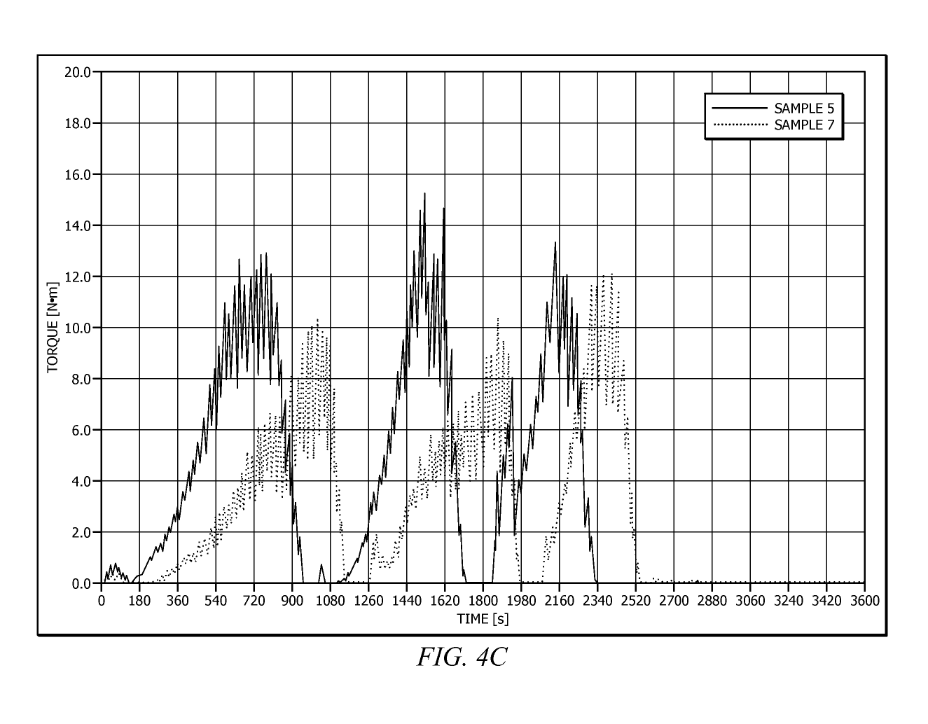

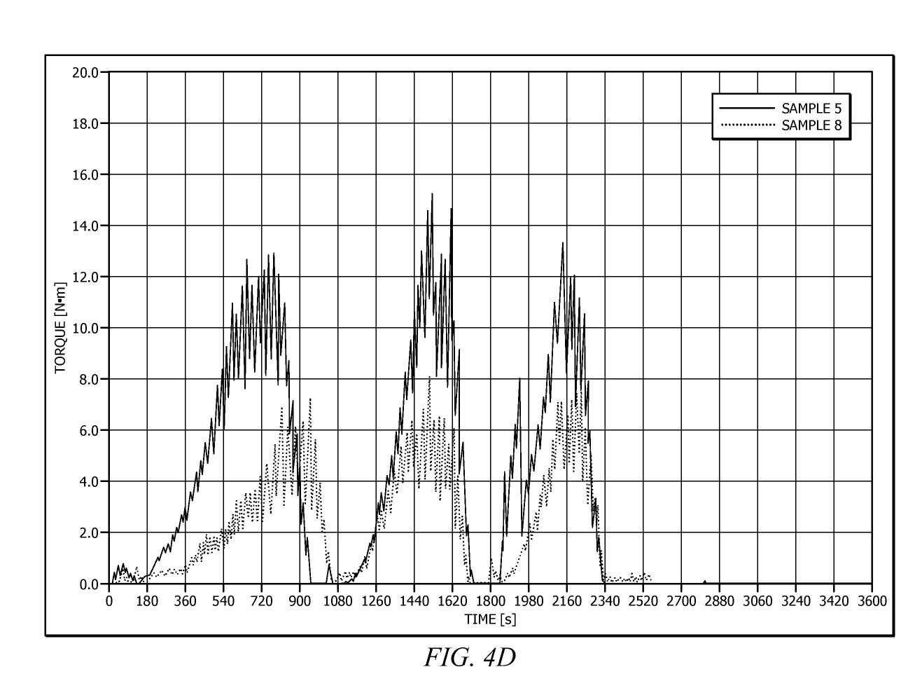

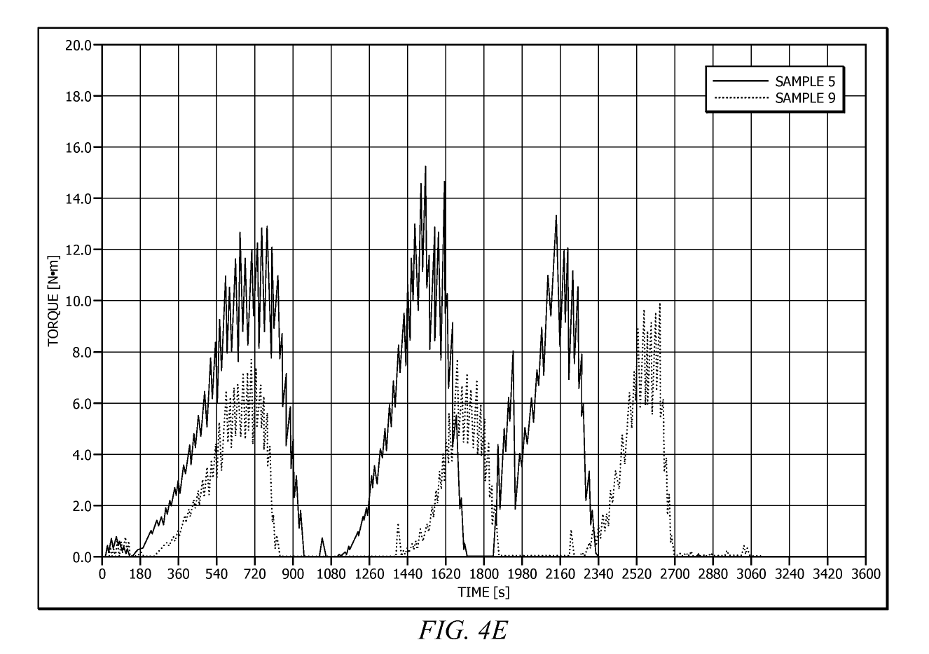

The effect of a by-product treatment additive on salt solids particulate drying was studied. More specifically, the effect of the type of by-product treatment additive on the torque of the dryer motor was investigated. PPS was prepared as described in Example 1. Salt solids particulates were obtained from the drying step for samples that had not been treated during any process step with a by-product treatment additive. The salt solids particulates were ground using a mill, and the resulting material was reconstituted with NMP and water to yield a reconstituted material slurry. Generally, 100 grams of ground salt solids particulates were reconstituted with 300 grams of NMP and from about 50 grams to about 100 grams of water. Sample #5 was prepared with no by-product treatment additive, while Samples #6, #7, #8, and #9 were prepared by adding the by-product treatment additives indicated in Table 2 to the reconstituted material and thoroughly mixing the reconstituted material slurry. In the case of Sample #6 and Sample #7, 4.5 grams of by-product treatment additive was added per 100 grams of salt solids particulates. For Sample #8 and Sample #9, by-product treatment additive was added in an amount effective to reach a desired pH value as indicated in Table 2. The reconstituted material slurry was then vacuum dried, and the dried material was weighed to 50 grams per sample and added to a mixing bowl of the Brabender lab dryer. The mixing bowl was heated to 225° C. and the rotation of the bowl was set to 8 rotations per minute (RPM). Approximately 20 mL of NMP was added to the mixing bowl to reconstitute the dried material into a slurry. The necessary amount of NMP was visually determined by observing the formation of a slurry. The torque of the dryer motor was recorded and the data are displayed in FIGS. 4A, 4B, 4C, 4D and 4E.

TABLE 2

| | By-Product Treatment | | |
|---|---|---|---|
| | Additive | Amount of Additive | pH Adjustment |
| Sample #5 | — | — | — |
| Sample #6 | sodium bicarbonate | 4.5 wt. % | — |
| Sample #7 | sodium carbonate | 4.5 wt. % | — |
| Sample #8 | acetic acid | effective amount | 8.0 |
| Sample #9 | dry ice (CO₂) | effective amount | 9.1 |

As it can be seen from FIGS. 4A, 4B, 4C, 4D and 4E, all by-product treatment additives used reduced the torque of the dryer motor when compared to the control (Sample #5) that contained no by-product treatment additive. Sample #8 had a pH value of 8.0, which was lower than the pH value of sample #9 (pH 9.1), and it also displayed a lower torque. The results for sodium bicarbonate (Sample #6) indicate that this salt is as effective as the acetic acid at pH 8 in reducing the torque of the dryer motor.

### Example 3

The effect of a by-product treatment additive on salt solids particulate drying was studied. PPS was prepared as described in Example 1, and a by-product slurry was further processed in a dryer. For the first 9 days of running the PPS production process, no by-product treatment additive was used, and the production process had to be interrupted for washing the dryer to remove agglomerations of salt solids particulates on days 0, 5, 8 and 9. On day 6, the dryer motor started to slow down due to agglomerations of salt solids particulates (e.g., due a torque increase). Starting with day 10, acetic acid (e.g., by-product treatment additive) was added in the process and this resulted in a lower torque of the dryer motor and no need for washing the dryer. Acetic acid was added on days 10, 14, 16, 20, 23, 26, 29, 30, and 32. The acetic acid was added as a 60% solution. The acetic acid was added in an amount calculated to neutralize the slurry it was added to, e.g., in an amount calculated to bring the pH of the slurry below 9.

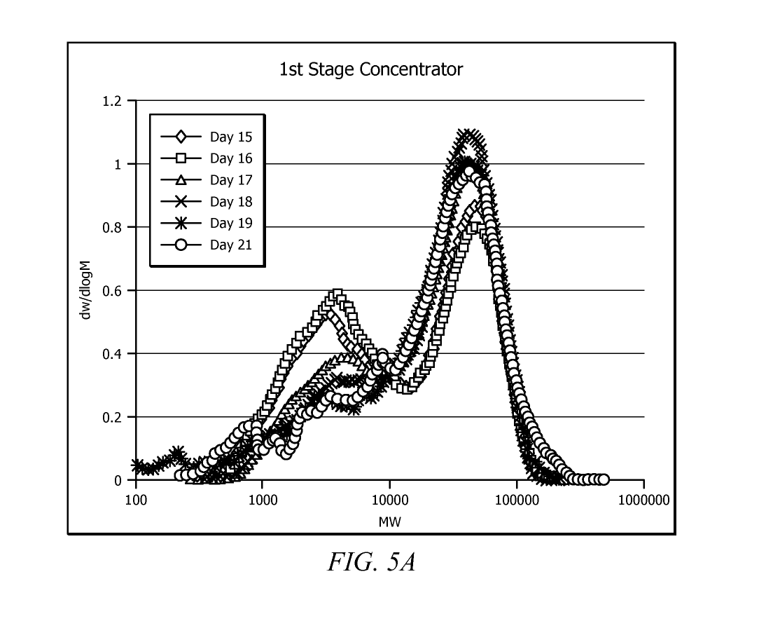

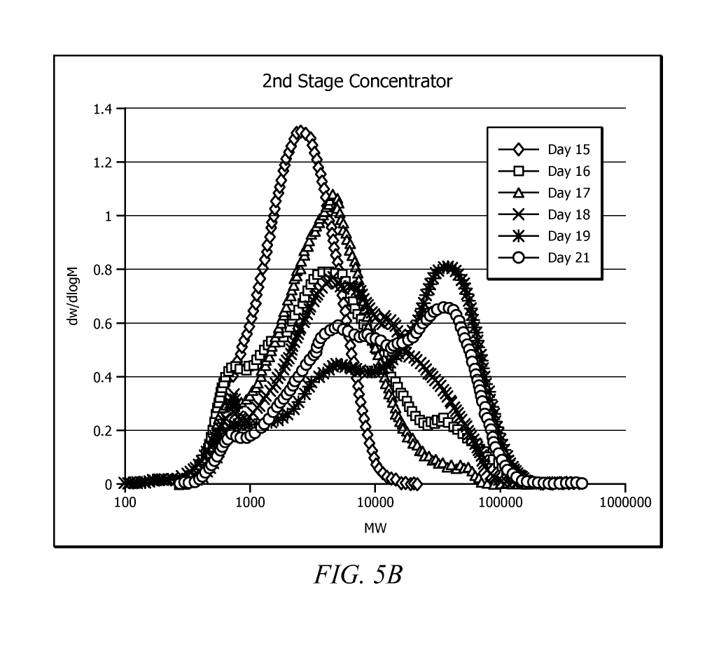

During the PPS production process, the first slurry was concentrated in two steps in a first (1^{st}) stage concentrator followed by a second (2^{nd}) stage concentrator. Polymer impurities (e.g., PPS fines, PPS oligomers, low molecular weight PPS, polymerization reaction side-products, polymerization reaction by-products) were recovered from each concentrator at various time points during the PPS production process (e.g., day 15, day 16, day 17, day 18, day 19, and day 21). Since acetic acid treatment started on day 10, days 15, 16, 17, 18, 19, and 21 represent 5, 6, 7, 8, 9, and 11 days of acetic acid treatment, respectively. The molecular weight profile of the polymer impurities was analyzed by gel permeation chromatography (GPC), according to following method: GPC analysis was conducted on a Polymer Labs PL-GPC220 high temperature GPC unit at 210° C. using chloronaphthalene as the mobile phase on Agilent mixed bed columns. Detection was accomplished using a Polymer Labs ELS-1000 evaporative light scattering detector. Molecular weight (MW) was determined based on calibration with mono-disperse polystyrene standards run under identical conditions. The resulting data are displayed in FIG. 5A for the first stage concentrator and in FIG. 5B for the second stage concentrator. The data in FIGS. 5A and 5B represent molecular weight (MW) distributions from GPC experiments, wherein each graph line represents the relative abundance of each MW slice. The data were collected for various time frames from 5 days of treatment with a by-product treatment additive to 11 days of treatment with a by-product treatment additive for each concentrator.

As it can be seen from FIGS. 5A and 5B, the polymer impurities recovered from the second stage concentrator display less degradation over time, as illustrated by the appearance of a higher molecular weight peak during treatment with a by-product treatment additive and by the increase in the size of this peak over time. When the polymer impurities degrade, such degradation can be a contributing factor to increasing the torque of the dryer motor. By reducing or eliminating the degradation of polymer impurities, the drying process and operations downstream the dryer can be improved. Further, un-degraded polymer impurities can be recovered as a useful product and used without further processing, whereas degraded polymer impurities could not be used without further processing.

### Example 4

The effect of a by-product treatment additive on salt solids particulate drying was studied. More specifically, the effect of the type of by-product treatment additive on the torque of the dryer motor was investigated. PPS was prepared as described in Example 1. The samples were reconstituted and dried in a Brabender lab dryer as described in Example 2. While drying the samples in the Brabender lab dryer, the torque was measured, and for each sample the torque value was reported as a % increase over the torque of the empty dryer, as it can be seen in Table 3 (XS=excess).

TABLE 3

| Element | Sample #10 | Sample #11 | Sample #12 | Sample #13 | Sample #14 | Sample #15 | Sample #16 |
|---|---|---|---|---|---|---|---|
| By-Product | — | XS H₂O | NaHCO₃ | Na₂CO₃ | NaHCO₃ | acetic | acetic acid |
| Treatment | | | XS H₂O | XS H₂O | Low H₂O | acid | XS H₂O |
| Additive | | | | | | low H₂O | pH 8 |
| | | | | | | pH 8 | |
| Torque | 7% | 2.5% | 0.3% | 0.3% | 5.6% | 3.7% | 1.2% |

Table 3 indicates by-product treatment additives (e.g., NaHCO₃, Na₂CO₃ and acetic acid) all have a positive impact in reducing the torque during drying. The data also indicates that these additives have the highest impact if excess water is present during reconstitution of the dried samples (e.g., Sample #12 vs. Sample #14; Sample #16 vs. Sample #15). Without wishing to be limited by theory, it is possible that the excess water could provide for better mobility for the by-product treatment additives.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed herein are provided solely for their disclosure prior to the filing date of the present application. Nothing herein is to be construed as an admission that the inventors are not entitled to antedate such disclosure by virtue of prior invention.

In any application before the United States Patent and Trademark Office, the Abstract of this application is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can be suggest to one of ordinary skill in the art without departing from the spirit of the present invention or the scope of the appended claims.

### ADDITIONAL DISCLOSURE

The following enumerated embodiments are provided as non-limiting examples.

A first embodiment, which is a process for producing a poly(arylene sulfide) polymer comprising:

(a) polymerizing reactants in a reaction vessel to produce a poly(arylene sulfide) reaction mixture;

(b) processing at least a portion of the poly(arylene sulfide) reaction mixture to obtain a poly(arylene sulfide) reaction mixture downstream product; and

(c) contacting a by-product treatment additive with at least a portion of the poly(arylene sulfide) reaction mixture and/or downstream product thereof; and

(d) processing at least a portion of the poly(arylene sulfide) reaction mixture downstream product to yield salt solids particulates, wherein the by-product treatment additive reduces agglomeration of the salt solids particulates.

A second embodiment, which is the process of the first embodiment, wherein (b) processing the poly(arylene sulfide) reaction mixture comprises quenching the reaction mixture by adding a quench liquid thereto, wherein the quench liquid comprises the by-product treatment additive.

A third embodiment, which is the process of any of the first through the second embodiments, wherein (b) processing the poly(arylene sulfide) reaction mixture comprises washing the at least a portion of the poly(arylene sulfide) reaction mixture with a polar organic compound and/or water to obtain a washed poly(arylene sulfide) polymer and a first slurry.

A fourth embodiment, which is the process of the third embodiment, wherein the by-product treatment additive is contacted with the poly(arylene sulfide) reaction mixture concurrent with washing the poly(arylene sulfide) reaction mixture with the polar organic compound and/or water.

A fifth embodiment, which is the process of any of the third through the fourth embodiments, wherein the by-product treatment additive is contacted with at least a portion of the first slurry, and wherein the first slurry has a pH of from about 4 to about 11 after contacting with the by-product treatment additive.

A sixth embodiment, which is the process of any of the third through the fifth embodiments, wherein the by-product treatment additive is contacted with at least a portion of the first slurry, and wherein the first slurry has a pH of from about 7.5 to about 9.5 after contacting with the by-product treatment additive.

A seventh embodiment, which is the process of any of the third through the sixth embodiments, further comprising evaporating at least a portion of the first slurry to obtain a by-product slurry, wherein at least a portion of the by-product slurry is evaporated to yield the salt solids particulates.

An eighth embodiment, which is the process of the seventh embodiment, wherein the by-product treatment additive is contacted with at least a portion of the by-product slurry.

A ninth embodiment, which is the process of any of the first through the eighth embodiments, wherein the poly(arylene sulfide) reaction mixture downstream product comprises a by-product slurry, and wherein the by-product treatment additive is contacted with at least a portion of the by-product slurry.

A tenth embodiment, which is the process of the ninth embodiment, wherein the by-product slurry comprises poly(arylene sulfide) polymer impurities.

An eleventh embodiment, which is the process of the tenth embodiment, wherein the poly(arylene sulfide) polymer impurities comprise poly(arylene sulfide) polymer fines, poly(arylene sulfide) oligomers, poly(arylene sulfide) low molecular weight polymers, polymerization reaction side-products, polymerization reaction by-products, or combinations thereof.

A twelfth embodiment, which is the process of any of the tenth through the eleventh embodiments, wherein the by-product treatment additive decreases the degradation of the poly(arylene sulfide) polymer impurities.

A thirteenth embodiment, which is the process of any of the tenth through the twelfth embodiments, wherein a weight average molecular weight of the poly(arylene sulfide) polymer impurities is by from about 1.01 times greater to about 40 times greater than a weight average molecular weight of poly(arylene sulfide) polymer impurities of an otherwise similar by-product slurry in the absence of treatment with the by-product treatment additive.

A fourteenth embodiment, which is the process of the seventh embodiment, wherein evaporating the by-product slurry to yield salt solids particulates further comprises introducing the by-product slurry to a dryer, wherein the dryer comprises a dryer motor that imparts a rotational motion to one or more internal elements of the dryer.

A fifteenth embodiment, which is the process of the fourteenth embodiment, wherein a torque of the dryer motor is reduced by from about 20% to about 100% when compared to a torque of the dryer motor used for evaporating an otherwise similar by-product slurry in the absence of treatment with the by-product treatment additive.

A sixteenth embodiment, which is the process of any of the fourteenth through the fifteenth embodiments, wherein the dryer comprises a salt solids particulates outlet, wherein the salt solids particulates outlet has a circular cross section, and wherein a ratio of a size of the salt solids particulates to the diameter of the circular cross section of the salt solids particulates outlet is less than about 0.9.

A seventeenth embodiment, which is the process of any of the fourteenth through the sixteenth embodiments, wherein a size of the salt solids particulates is reduced by from about 5% to about 95% when compared to a size of the salt solids particulates obtained by evaporating an otherwise similar by-product slurry in the absence of treatment with the by-product treatment additive.

An eighteenth embodiment, which is the process of the seventh embodiment, wherein the by-product slurry comprises slurry particulates, and wherein a ratio of a size of the salt solids particulates to a size of the slurry particulates is less than about 10.

A nineteenth embodiment, which is the process of any of the first through the eighteenth embodiments, wherein the salt solids particulates comprise an alkali metal halide by-product in an amount of from about 50 wt. % to about 99 wt. %, based on the total weight of the salt solids particulates.

A twentieth embodiment, which is the process of any of the first through the nineteenth embodiments, wherein the salt solids particulates comprise polymer impurities in an amount of from about 1 wt. % to about 50 wt. %, based on the total weight of the salt solids particulates.

A twenty-first embodiment, which is the process of the nineteenth embodiment, wherein the alkali metal halide by-product comprises NaCl.

A twenty-second embodiment, which is the process of any of the first through the twenty-first embodiments, wherein polymerizing reactants further comprises reacting a sulfur source and a dihaloaromatic compound in the presence of a polar organic compound to form the poly(arylene sulfide) polymer.

A twenty-third embodiment, which is the process of any of the first through the twenty-second embodiments, wherein the poly(arylene sulfide) is a poly(phenylene sulfide).

A twenty-fourth embodiment, which is the process of the fourteenth embodiment, wherein the by-product treatment additive is contacted with the poly(arylene sulfide) reaction mixture and/or downstream product thereof in an amount effective to reduce a torque of the dryer motor used for evaporating at least a portion of the by-product slurry by from about 20% to about 100% when compared to a torque of the dryer motor used for evaporating an otherwise similar by-product slurry in the absence of treatment with the by-product treatment additive.

A twenty-fifth embodiment, which is the process of the seventh embodiment, wherein the by-product treatment additive is contacted with the poly(arylene sulfide) reaction mixture and/or downstream product thereof in an amount effective to reduce a size of the salt solids particulates obtained by evaporating at least a portion of the by-product slurry by from about 5% to about 95% when compared to a size of the salt solids particulates obtained by evaporating an otherwise similar by-product slurry in the absence of treatment with the by-product treatment additive.

A twenty-sixth embodiment, which is the process of any of the first through the twenty-fifth embodiments, wherein the by-product treatment additive is contacted with the poly(arylene sulfide) reaction mixture and/or downstream product thereof in an amount effective to yield a pH of a first slurry of from about 4 to about 11.

A twenty-seventh embodiment, which is the process of any of the first through the twenty-sixth embodiments, wherein the by-product treatment additive comprises an acid, a non-oxidizing acid, an organic acid, a mineral acid, an acid precursor, a salt, or combinations thereof.

A twenty-eighth embodiment, which is the process of any of the first through the twenty-seventh embodiments, wherein the by-product treatment additive comprises acetic acid, propionic acid, formic acid, hydrochloric acid, carbon dioxide, dry ice, sodium carbonate, sodium bicarbonate, potassium carbonate, potassium bicarbonate, sodium acetate, potassium acetate, acid containing clays, silica, or combinations thereof.

A twenty-ninth embodiment, which is a process for producing a poly(arylene sulfide) polymer comprising:

(a) polymerizing reactants in a reaction vessel to produce a poly(arylene sulfide) reaction mixture;

(b) washing at least a portion of the poly(arylene sulfide) reaction mixture with a polar organic compound and/or water to obtain a poly(arylene sulfide) polymer and a first slurry;

(c) contacting at least a portion of the first slurry with a by-product treatment additive to yield a treated first slurry having a pH of from about 4 to about 11;

(d) evaporating at least portion of the treated first slurry to obtain a by-product slurry comprising poly(arylene sulfide) polymer impurities, wherein a weight average molecular weight of the poly(arylene sulfide) polymer impurities is by from about 1.01 times greater to about 40 times greater than a weight average molecular weight of poly(arylene sulfide) polymer impurities of an otherwise similar by-product slurry in the absence of treatment with the by-product treatment additive; and

(e) evaporating at least portion of the by-product slurry to yield salt solids particulates, wherein the by-product treatment additive reduces agglomeration of the salt solids particulates.

A thirtieth embodiment, which is a process for producing a poly(arylene sulfide) polymer comprising:

(a) polymerizing reactants in a reaction vessel to produce a poly(arylene sulfide) reaction mixture;

(b) contacting at least a portion of the poly(arylene sulfide) reaction mixture with a by-product treatment additive to yield a treated poly(arylene sulfide) reaction mixture;

(c) washing at least a portion of the treated poly(arylene sulfide) reaction mixture with a polar organic compound and/or water to obtain a poly(arylene sulfide) polymer and a first slurry having a pH of from about 4 to about 11;

(d) evaporating at least portion of the first slurry to obtain a by-product slurry comprising poly(arylene sulfide) polymer impurities, wherein a weight average molecular weight of the poly(arylene sulfide) polymer impurities is by from about 1.01 times greater to about 40 times greater than a weight average molecular weight of poly(arylene sulfide) polymer impurities of an otherwise similar by-product slurry in the absence of treatment with the by-product treatment additive; and

(e) evaporating at least portion of the by-product slurry to yield salt solids particulates, wherein the by-product treatment additive reduces agglomeration of the salt solids particulates.

A thirty-first embodiment, which is a system for producing a poly(arylene sulfide) polymer comprising:

(a) a reactor, wherein a sulfur source and a dihaloaromatic compound are reacted in the presence of a polar organic compound to form a poly(arylene sulfide) reaction mixture; and

(b) a solvent recovery system receiving at least a portion of the poly(arylene sulfide) reaction mixture, wherein the solvent recovery system comprises:
(i) a washing vessel receiving at least a portion of the poly(arylene sulfide) reaction mixture, wherein at least a portion of the poly(arylene sulfide) reaction mixture is washed with the polar organic compound and/or water to obtain a washed poly(arylene sulfide) polymer and a first slurry;
(ii) a tank receiving at least a portion of the first slurry, wherein the first slurry has pH of from about 4 to about 11;
(iii) a concentrator receiving at least portion of the first slurry having a pH of from about 4 to about 11, wherein at least a portion of the first slurry having a pH of from about 4 to about 11 is evaporated to yield a by-product slurry; and
(iv) a dryer receiving at least portion of the by-product slurry, wherein at least portion of the by-product slurry is evaporated to yield salt solids particulates;

wherein a by-product treatment additive is added to the solvent recovery system in the b(i) washing vessel, the b(ii) tank and/or the b(iii) concentrator; and

wherein the by-product treatment additive reduces agglomeration of the salt solids particulates in the b(iv) dryer.

While embodiments of the disclosure have been shown and described, modifications thereof can be made without departing from the spirit and teachings of the invention. The embodiments and examples described herein are exemplary only, and are not intended to be limiting. Many variations and modifications of the invention disclosed herein are possible and are within the scope of the invention.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

What is claimed is:

1. A process for producing a poly(arylene sulfide) polymer comprising:
(a) polymerizing reactants in a reaction vessel to produce a poly(arylene sulfide) reaction mixture;
(b) processing at least a portion of the poly(arylene sulfide) reaction mixture to obtain a poly(arylene sulfide) reaction mixture downstream product; and
(c) contacting a by-product treatment additive with at least a portion of the poly(arylene sulfide) reaction mixture and/or downstream product thereof; and
(d) processing at least a portion of the poly(arylene sulfide) reaction mixture downstream product to yield salt solids particulates, wherein the by-product treatment additive reduces agglomeration of the salt solids particulates.

2. The process of claim 1, wherein (b) processing the poly(arylene sulfide) reaction mixture comprises quenching the reaction mixture by adding a quench liquid thereto, wherein the quench liquid comprises the by-product treatment additive.

3. The process of claim 1, wherein (b) processing the poly(arylene sulfide) reaction mixture comprises washing the at least a portion of the poly(arylene sulfide) reaction mixture with a polar organic compound and/or water to obtain a washed poly(arylene sulfide) polymer and a first slurry.

4. The process of claim 3, wherein the by-product treatment additive is contacted with the poly(arylene sulfide) reaction mixture concurrent with washing the poly(arylene sulfide) reaction mixture with the polar organic compound and/or water.

5. The process of claim 3, wherein the by-product treatment additive is contacted with at least a portion of the first slurry, and wherein the first slurry has a pH of from about 4 to about 11 after contacting with the by-product treatment additive.

6. The process of claim 3, further comprising evaporating at least a portion of the first slurry to obtain a by-product slurry, wherein the by-product slurry comprises poly(arylene sulfide) polymer impurities, and wherein at least a portion of the by-product slurry is evaporated to yield the salt solids particulates.

7. The process of claim 6, wherein the by-product treatment additive is contacted with at least a portion of the by-product slurry.

8. The process of claim 6, wherein the poly(arylene sulfide) polymer impurities comprise poly(arylene sulfide) polymer fines, poly(arylene sulfide) oligomers, poly(arylene sulfide) low molecular weight polymers, polymerization reaction side-products, polymerization reaction by-products, or combinations thereof.

9. The process of claim 6, wherein the by-product treatment additive decreases the degradation of the poly(arylene sulfide) polymer impurities.

10. The process of claim 6, wherein a weight average molecular weight of the poly(arylene sulfide) polymer impurities is by from about 1.01 times greater to about 40 times greater than a weight average molecular weight of poly(arylene sulfide) polymer impurities of an otherwise similar by-product slurry in the absence of treatment with the by-product treatment additive.

11. The process of claim 6, wherein evaporating the by-product slurry to yield salt solids particulates further comprises introducing the by-product slurry to a dryer, wherein the dryer comprises a dryer motor that imparts a rotational motion to one or more internal elements of the dryer.

12. The process of claim 11, wherein a torque of the dryer motor is reduced by from about 20% to about 100% when compared to a torque of the dryer motor used for evaporating an otherwise similar by-product slurry in the absence of treatment with the by-product treatment additive.

13. The process of claim 11, wherein a size of the salt solids particulates is reduced by from about 5% to about 95% when compared to a size of the salt solids particulates obtained by evaporating an otherwise similar by-product slurry in the absence of treatment with the by-product treatment additive.

14. The process of claim 11, wherein the by-product treatment additive is contacted with the poly(arylene sulfide) reaction mixture and/or downstream product thereof in an amount effective to reduce a torque of the dryer motor used for evaporating at least a portion of the by-product slurry by from about 20% to about 100% when compared to a torque of the dryer motor used for evaporating an otherwise similar by-product slurry in the absence of treatment with the by-product treatment additive.

15. The process of claim 6, wherein the by-product treatment additive is contacted with the poly(arylene sulfide) reaction mixture and/or downstream product thereof in an amount effective to reduce a size of the salt solids particulates obtained by evaporating at least a portion of the by-product slurry by from about 5% to about 95% when compared to a size of the salt solids particulates obtained by evaporating an otherwise similar by-product slurry in the absence of treatment with the by-product treatment additive.

16. The process of claim 1, wherein the by-product treatment additive is contacted with the poly(arylene sulfide) reaction mixture and/or downstream product thereof in an amount effective to yield a pH of a first slurry of from about 4 to about 11.

17. The process of claim 1, wherein the by-product treatment additive comprises an acid, a non-oxidizing acid, an organic acid, a mineral acid, an acid precursor, a salt, or combinations thereof.

18. The process of claim 1, wherein the by-product treatment additive comprises acetic acid, propionic acid, formic acid, hydrochloric acid, carbon dioxide, dry ice, sodium carbonate, sodium bicarbonate, potassium carbonate, potassium bicarbonate, sodium acetate, potassium acetate, acid containing clays, silica, or combinations thereof.

19. A process for producing a poly(arylene sulfide) polymer comprising:
(a) polymerizing reactants in a reaction vessel to produce a poly(arylene sulfide) reaction mixture;
(b) washing at least a portion of the poly(arylene sulfide) reaction mixture with a polar organic compound and/or water to obtain a poly(arylene sulfide) polymer and a first slurry;
(c) contacting at least a portion of the first slurry with a by-product treatment additive to yield a treated first slurry having a pH of from about 4 to about 11;
(d) evaporating at least portion of the treated first slurry to obtain a by-product slurry comprising poly(arylene sulfide) polymer impurities, wherein a weight average molecular weight of the poly(arylene sulfide) polymer impurities is by from about 1.01 times greater to about 40 times greater than a weight average molecular weight of poly(arylene sulfide) polymer impurities of an otherwise similar by-product slurry in the absence of treatment with the by-product treatment additive; and
(e) evaporating at least portion of the by-product slurry to yield salt solids particulates, wherein the by-product treatment additive reduces agglomeration of the salt solids particulates.

20. A process for producing a poly(arylene sulfide) polymer comprising:
(a) polymerizing reactants in a reaction vessel to produce a poly(arylene sulfide) reaction mixture;
(b) contacting at least a portion of the poly(arylene sulfide) reaction mixture with a by-product treatment additive to yield a treated poly(arylene sulfide) reaction mixture;
(c) washing at least a portion of the treated poly(arylene sulfide) reaction mixture with a polar organic compound and/or water to obtain a poly(arylene sulfide) polymer and a first slurry having a pH of from about 4 to about 11;
(d) evaporating at least portion of the first slurry to obtain a by-product slurry comprising poly(arylene sulfide) polymer impurities, wherein a weight average molecular weight of the poly(arylene sulfide) polymer impurities is by from about 1.01 times greater to about 40 times greater than a weight average molecular weight of poly(arylene sulfide) polymer impurities of an otherwise similar by-product slurry in the absence of treatment with the by-product treatment additive; and
(e) evaporating at least portion of the by-product slurry to yield salt solids particulates, wherein the by-product treatment additive reduces agglomeration of the salt solids particulates.
